(19) United States
(12) Patent Application Publication
(10) Pub. No.: US 2024/0397401 A1
(43) Pub. Date: Nov. 28, 2024

(54) Method for Estimating Cell Load Rate and Adjusting Communication Service, and Corresponding Electronic Device

(71) Applicant: Huawei Technologies Co., Ltd., Shenzhen (CN)

(72) Inventors: Chao Huang, Shenzhen (CN); Ao Guo, Shanghai (CN); Fengguang Qiu, Shenzhen (CN)

(21) Appl. No.: 18/694,543

(22) PCT Filed: Aug. 23, 2022
(86) PCT No.: PCT/CN2022/114336

§ 371 Date: Mar. 22, 2024

(30) Foreign Application Priority Data
Sep. 26, 2021 (CN) 202111128108.5

(51) Int. Cl. H04W 36/22; H04W 36/30

(52) U.S. Cl. CPC H04W 36/22; H04W 36/302

(57) ABSTRACT

A communication method includes measuring a received signal strength indicator (RSSI) and a reference signal received power (RSRP) of a serving cell in which a user equipment is located; calculating a load rate of the serving cell based on the RSSI, the RSRP, and at least one of a quantity of antenna transmit ports of a base station communicating with the user equipment, a probability of synchronization between the serving cell of the user equipment and each of neighboring cells, a probability of asynchronization between the serving cell and the neighboring cells, a ratio of power of a data signal from the base station to power of a pilot signal from the base station, or interference caused by the neighboring cells to the serving cell; and determining, based on the load rate of the serving cell and a cell congestion threshold, whether the serving cell is congested.

This application claims priority to Chinese Patent Application No. 202111128108.5,filed with the China National Intellectual Property Administration on Sep. 26, 2021 and entitled “METHOD FOR ESTIMATING CELL LOAD RATE AND ADJUSTING COMMUNICATION SERVICE, AND CORRESPONDING ELECTRONIC DEVICE”, which is incorporated herein by reference in its entirety.

### TECHNICAL FIELD

This application relates to the field of mobile communication technologies, and in particular, to a method for estimating a cell load rate and adjusting a communication service, and a corresponding electronic device.

### BACKGROUND

In daily data services, although a mobile phone interface displays full signal strength, an application being used by a user may still experience slow network access. For example, during use of applications such as Baidu and Toutiao, information is usually not loaded, or during use of video applications such as TikTok, lagging occurs.

These cases happen not for only one reason. The reason may be that a serving cell on which the mobile phone camps is congested or that load imbalance occurs on a server providing the application (for example a server providing the foregoing application such as Baidu or Tik Tok). Solutions for the two cases may be different. For example, the problem of cell congestion may be resolved through cell handover or operator switching, and the problem of server imbalance may be resolved by adjusting load balancing of the server providing the application.

If the cause of slow network access can be identified and the problem is resolved in a targeted manner, a probability of resolving the problem will be increased, and user experience will be improved.

### SUMMARY

To resolve the foregoing disadvantages and perform more targeted cell handover or secondary card switching, this application proposes a communication method for user equipment (User Equipment, UE). The communication method includes:
measuring a received signal strength indicator (Received Signal Strength Indicator, RSSI) and pilot signal received power (Reference Signal Received Power, RSRP) of a serving cell in which the user equipment is located;
calculating a load rate of the serving cell at least partially based on the RSSI, the RSRP, and at least one of the following information, where the following information includes: a quantity of antenna transmit ports of a base station communicating with the user equipment, a probability of synchronization between the serving cell of the user equipment and each of neighboring cells, a probability of asynchronization between the serving cell and each of the neighboring cells, a ratio of power of a data signal sent by the base station to power of a pilot signal sent by the base station, and interference caused by the neighboring cells to the serving cell, and the serving cell is adjacent to each of the neighboring cells; and
determining, at least partially based on the load rate of the serving cell and a cell congestion threshold, whether the serving cell is congested.

Compared with a conventional technology, the solution of cell handover or primary/secondary card switching provided in this application is dominated by the client (UE end). On the basis of the measured RSRP and RSSI, an existing load rate calculation formula is modified (calculated) based on different impact on received signal power caused by a plurality of factors such as the quantity of antenna transmit ports of the base station communicating with the user equipment, the probability of synchronization between the serving cell of the user equipment and each of the neighboring cells, the probability of asynchronization between the serving cell and each of the neighboring cells, the ratio of the power of the data signal sent by the base station to the power of the pilot signal sent by the base station, and the interference caused by the neighboring cells to the serving cell, so that the obtained load rate is a more real cell load rate, and a reason why a network speed of the client is not fast enough can be determined more accurately. This provides a factual basis for subsequent processing.

In the foregoing communication method, the calculating a load rate of the serving cell at least partially based on the RSSI, the RSRP, and at least one of the following information includes: calculating a load rate of the neighboring cells; and calculating, at least partially based on the load rate of the neighboring cells, the interference caused by the neighboring cells to the serving cell.

In the foregoing communication method, the calculating a load rate of the neighboring cells includes: measuring a signal to interference plus noise ratio (Signal to Interference plus Noise Ratio, SINR) of the serving cell, and obtaining RSRP of the neighboring cells; and calculating the load rate of the neighboring cells at least partially based on the RSRP and the SINR of the serving cell, the RSRP of the neighboring cells, and at least one of the following information, where the following information includes: the quantity of antenna transmit ports of the base station, the probability of synchronization between the serving cell and each of the neighboring cells, the probability of asynchronization between the serving cell and each of the neighboring cells, and the ratio of the data signal power to the pilot signal power.

In the foregoing communication method, the calculating a load rate of the neighboring cells includes: calculating the load rate of the neighboring cells by using the following formula:

$$\frac{\begin{matrix}\frac{RSRP of the serving cell}{SINR of the serving cell} - Noise power on a pilot RE of the serving cell - \\ Sum of RSRP of intra - frequency synchronous neighboring cells in the neighboring cells\end{matrix}}{\begin{matrix}Sum of data signal power of the neighboring cells on a unit RE \\ measured by the user equipment in the case of full load\end{matrix}} ,$$

A subcarrier frequency of the intra-frequency synchronous neighboring cell is the same as a subcarrier frequency of the serving cell, the intra-frequency synchronous neighboring cell is synchronous with the serving cell, and the pilot RE (Resource Element, resource element) is an RE that carries the pilot signal. Calculating the sum of the RSRP of the intra-frequency synchronous neighboring cells and calculating the sum of the data signal power on the unit RE are related to at least one of the following information, where the following information includes: the quantity of antenna transmit ports of the base station, the probability of synchronization between the serving cell and each of the neighboring cells, the probability of asynchronization between the serving cell and each of the neighboring cells, and the ratio of the data signal power to the pilot signal power.

In the foregoing communication method, the calculating a load rate of the neighboring cells includes: calculating the load rate of the neighboring cells by using the following formula:

$${L}_{N} = \frac{( \frac{RSRP ( i = 0 )}{SINR ( i = 0 )} ) - {N}_{0} - {\sum }_{i ∈ Intra - frequency neighboring cells} ( P ( B ) \times RSRP ( i ) )}{\begin{matrix}{\sum }_{i ∈ Intra - frequency neighboring cells} ( P ( A ) \times n \times {ρ}_{A} \times RSRP ( i ) ) + \\ {\sum }_{i ∈ Inter - frequency neighboring cells} ( P ( A ) \times {ρ}_{A} + P ( B ) \times {ρ}_{B} ) \times n \times RSRP ( i )\end{matrix}} ,$$

i represents a cell number, i=0 represents the serving cell,

$$( \frac{RSRP ( i = 0 )}{SINR ( i = 0 )} )$$

represents a ratio of the RSRP of the serving cell to the SINR of the serving cell, N₀ is noise on a pilot RE of the serving cell, RSRP(i) represents RSRP of a neighboring cell whose number is i, P(A) is the probability of asynchronization between each of the neighboring cells and the serving cell, P(B) is the probability of synchronization between each of the neighboring cells and the serving cell, ρ_{A} is a ratio of data signal power to pilot signal power on a non-pilot symbol, ρ_{B} is a ratio of data signal power to pilot signal power on a pilot symbol, and n is the quantity of antenna transmit ports of the base station.

In the foregoing communication method, the calculating, at least partially based on the load rate of the neighboring cells, the interference caused by the neighboring cells to the serving cell includes: calculating, based on the load rate of the neighboring cells and at least one of the following information, the interference caused by the neighboring cells to the serving cell, where the following information includes: the quantity of antenna transmit ports of the base station, the probability of synchronization between the serving cell and each of the neighboring cells, the probability of asynchronization between the serving cell and each of the neighboring cells, and the ratio of the power of the data signal sent by the base station to the power of the pilot signal sent by the base station.

In the foregoing communication method, the calculating, at least partially based on the load rate of the neighboring cells, the interference caused by the neighboring cells to the serving cell includes: calculating, by using the following formula, the interference caused by the neighboring cells to the serving cell:

(sum of the data signal power of the neighboring cells measured by the user equipment on an OFDM symbol and in total bandwidth in the case of full load)×load rate of the neighboring cells+(sum of the RSRP of the intra-frequency synchronous neighboring cells on the OFDM symbol and in the total bandwidth)

A carrier frequency of the intra-frequency synchronous neighboring cell is the same as a carrier frequency of the serving cell, and the intra-frequency synchronous neighboring cell is synchronous with the serving cell. Calculating the sum of the data signal power of the neighboring cells on the OFDM (Orthogonal Frequency Division Multiplexing, orthogonal frequency division multiplexing) symbol and in the total bandwidth and calculating the sum of the RSRP of the intra-frequency synchronous neighboring cells on the OFDM symbol and in the total bandwidth are related to at least one of the following information, where the following information includes: the quantity of antenna transmit ports of the base station, the probability of synchronization between the serving cell and each of the neighboring cells, the probability of asynchronization between the serving cell and each of the neighboring cells, and the ratio of the data signal power to the pilot signal power.

In the foregoing communication method, the calculating, at least partially based on the load rate of the neighboring cells, the interference caused by the neighboring cells includes: calculating the interference by using the following formula.

$${\sum }_{i = 1}^{I} ( P ( A ) \times {ρ}_{A} \times RSRP ( i ) \times {NRS}_{RE - A} ( n ) \times N \times {L}_{N} + P ( B ) \times {RS}_{RE - B} ( n ) + {ρ}_{B} \times {NRS}_{RE - B} ( n ) \times {L}_{N} ) \times RSRP ( i ) \times N )$$

I represents a maximum quantity of neighboring cells, i represents a number of the neighboring cell, RSRP(i) represents RSRP of a neighboring cell whose number is i, P(A) is the probability of asynchronization between each of the neighboring cells and the serving cell, P(B) is the probability of synchronization between each of the neighboring cells and the serving cell, ρ_{A} is a ratio of data signal power to pilot signal power on a non-pilot symbol, ρ_{B} is a ratio of data signal power to pilot signal power on a pilot symbol, N is a quantity of resource blocks (Resource Block, RB) corresponding to total cell bandwidth, n is the quantity of antenna ports of the base station, NRS_{RE-A}(n) is a quantity of resource elements (Resource Element, RE) that are on a non-pilot symbol in one RB and used to send a data signal, RS_{RE-B}(n) is a quantity of REs that are on a pilot symbol in one RB and used to send a pilot signal, and NRS_{RE-B}(n) is a quantity of REs that are on a pilot symbol in one RB and used to send a data signal.

In the foregoing communication method, the calculating a load rate of the serving cell at least partially based on the RSSI, the RSRP, and at least one of the following information further includes: calculating the load rate of the serving cell by using the following formula:

$$\frac{\begin{matrix}RSSI - Sum of the RSRP of the serving cell on an OFDM \\ symbol and in total bandwidth - Noise in the total bandwidth - \\ interference caused by the neighboring cells to the serving cell\end{matrix}}{\begin{matrix}Sum of the data signal power of the serving \\ cell measured by the user equipment on the OFDM \\ symbol and in the total bandwidth in the case of full load\end{matrix}}$$

Calculating the sum of the RSRP of the serving cell on the OFDM symbol and in the total bandwidth, calculating the interference caused by the neighboring cells to the serving cell, and calculating the sum of the data signal power of the serving cell on the OFDM symbol and in the total bandwidth are related to at least one of the following information, where the following information includes: the quantity of antenna transmit ports of the base station, the probability of synchronization between the serving cell and each of the neighboring cells, the probability of asynchronization between the serving cell and each of the neighboring cells, and the ratio of the data signal power to the pilot signal power.

In the foregoing communication method, the calculating a load rate of the serving cell

at least partially based on the RSSI, the RSRP, and at least one of the following information includes: calculating the load rate of the serving cell by using the following formula:

$${L}_{0} = \frac{\begin{matrix}RSSI - N \times {RS}_{RE - B} ( n ) \times RSRP ( i ) - Noise - \\ {\sum }_{i = 1}^{J} ( P ( A ) \times {ρ}_{A} \times RSRP ( i ) \times {NRS}_{RE - A} ( n ) \times N \times {L}_{N} + \\ P ( B ) \times ( {RS}_{RE - B} ( n ) + {ρ}_{B} \times {NRS}_{RE - B} ( n ) \times {L}_{N} ) \times RSRP ( i ) \times N )\end{matrix}}{{ρ}_{B} \times RSRP ( i = 0 ) \times {NRS}_{RE - B} ( n ) \times N}$$

N is the quantity of resource blocks (Resource Block, RB) corresponding to the total cell bandwidth, n is the quantity of antenna ports of the base station, NRS_{RE-A}(n) is the quantity of resource elements (Resource Element, RE) that are on the non-pilot symbol and used to send data, RS_{RE-B}(n) is the quantity of REs that are on the pilot symbol and used to send a pilot, NRS_{RE-B}(n) is the quantity of REs that are on the pilot symbol and used to send data, Noise is power of background noise in the total cell bandwidth, I represents the maximum quantity of neighboring cells, i represents the number of the neighboring cell, RSRP(i) represents the RSRP of the neighboring cell, P(A) is the probability of asynchronization between each of the neighboring cells and the serving cell, P(B) is the probability of synchronization between each of the neighboring cells and the serving cell, ρ_{A} is the ratio of data signal power to pilot signal power on the non-pilot symbol, and ρ_{B} is the ratio of data signal power to pilot signal power on the pilot symbol.

The foregoing communication method further includes: determining, when it is determined that the serving cell is congested, whether to adjust a communication service between the user equipment and the base station.

In the foregoing communication method, the determining, when it is determined that the serving cell is congested, whether to adjust a communication service between the user equipment and the base station further includes.
comparing the RSRP of the neighboring cells with the RSRP of the serving cell;
when RSRP of one or more neighboring cells in the neighboring cells is greater than the RSRP of the serving cell, switching the serving cell of the user equipment to a neighboring cell with largest RSRP in the one or more neighboring cells;
calculating a load rate of the neighboring cell with the largest RSRP, and determining, based on the load rate of the neighboring cell with the largest RSRP, whether the neighboring cell with the largest RSRP is congested; and
when it is determined that the neighboring cell with the largest RSRP is not congested, determining to camp on the neighboring cell with the largest RSRP; or
when it is determined that the neighboring cell with the largest RSRP is congested, determining to switch a secondary card of the user equipment to a primary card.

The foregoing communication method further includes: when it is determined that the serving cell is not congested, comparing a communication quality index between the user equipment and the base station with a quality threshold: and reporting an exception to a server when the communication quality index between the user equipment and the base station reaches or exceeds the quality threshold.

This application further provides a computer-readable storage medium. The computer-readable storage medium stores computer instructions, and when the computer instructions are executed, the foregoing communication method is implemented.

This application further provides an electronic device, including: a memory, configured to store instructions executed by one or more processors; and a processor, where the processor is one of the processors of the electronic device and configured to perform the foregoing communication method.

The solution of cell handover or primary/secondary card switching provided in this application is dominated by the user end. On the basis of the measured RSSI (Received Signal Strength Indicator) and RSRP (Reference Signal Received Power, reference signal (pilot) received power), the user end further analyzes composition of the measured RSSI and RSRP values, and subtracts a part that does not belong to data power (also referred to as data energy below) from the foregoing measured values. Therefore, a ratio of data power represents the load rate of the cell. Compared with a conventional technology, in this application, based on the measured RSRP and RSSI values, data power (power of a pure data signal) that has been used in a serving cell and maximum data power that may occur in the serving cell are deduced from a statistical perspective. The load rate of the serving cell is obtained by using a ratio between the foregoing two types of pure data power that do not include noise or pilot signal power. The load rate is a more real cell load rate, so that a reason why the network speed of the user end is not fast enough can be more accurately determined. This provides a factual basis for subsequent processing.

### BRIEF DESCRIPTION OF DRAWINGS

FIG. 1 is a schematic diagram of a wireless communication network system according to some embodiments of this application;

FIG. 2 is a schematic diagram of a cellular cell according to some embodiments of this application;

FIG. 3 is a schematic diagram of user equipment including a functional unit used for cell load rate estimation according to some embodiments of this application;

FIG. 4A and FIG. 4B are a flowchart of estimating a cell load rate and adjusting a communication service based on the cell load rate according to some embodiments of this application;

FIG. 5 is a flowchart of a method for estimating a load rate of a serving cell in which user equipment is located according to some embodiments of this application;

FIG. 6A to FIG. 6C are a comparison diagram of resource blocks (Resource Block, RB) in a serving cell and each of neighboring cells, where each of the neighboring cells is adjacent to the serving cell; and

FIG. 7 is a schematic diagram of a system of user equipment according to some embodiments of this application.

### DESCRIPTION OF EMBODIMENTS

The following describes implementations of this application by using specific embodiments. A person skilled in the art may easily learn of other advantages and effects of this application based on content disclosed in this specification. Although this application is described with reference to preferred embodiments, this does not mean that features of the present invention are limited only to the implementations. On the contrary, a purpose of describing the present invention with reference to the implementations is to cover other selections or modifications that may be derived based on the claims of this application. To provide in-depth understanding of this application, the following descriptions include a plurality of specific details. This application may be alternatively implemented without using these details. In addition, to avoid confusion or blurring a focus of this application, some specific details are omitted from the description. It should be noted that embodiments in this application and the features in embodiments may be mutually combined in the case of no conflict.

Furthermore, various operations are described as a plurality of discrete operations in a

manner that is most conducive to understanding illustrative embodiments. However, an order of description should not be construed as implying that these operations need to depend on the order. In particular, these operations do not need to be performed in the provided order. It should be noted that, in this specification, similar reference numerals and letters in the following accompanying drawings represent similar items. Therefore, once an item is defined in an accompanying drawing, the item does not need to be further defined or interpreted in subsequent accompanying drawings.

It should be understood that although terms such as “first” and “second” may be used herein to describe various features, these features should not be limited by these terms. These terms are merely used for distinction, and shall not be understood as an indication or implication of relative importance. For example, without departing from the scope of the example embodiments, a first feature may be referred to as a second feature, and similarly the second feature may be referred to as the first feature.

Unless otherwise stated, terms “contain”, “have”, and “include” are synonymous. The phrase “A/B” indicates “A or B”. The phrase “A and/or B” indicates “(A), (B), or (A and B)”.

As used in this specification, the term “module”, “unit”, or “apparatus” may represent, or may be, or may include an application-specific integrated circuit (ASIC), an electronic circuit, a processor (shared, dedicated, or group) that executes one or more software or firmware programs and/or a memory (shared, dedicated, or group), combined logic circuits, and/or another suitable component that provides a described function, or may be a part of an application-specific integrated circuit (ASIC), an electronic circuit, a processor (shared, dedicated, or group) that executes one or more software or firmware programs and/or a memory (shared, dedicated, or group), combined logic circuits, and/or another suitable component that provides the described function.

It should be further stated that methods and processes are numbered in this application for ease of reference, but are not intended to limit a sequence. If steps are subject to a sequence, the text description shall prevail.

To make the objectives, technical solutions, and advantages of this application clearer, the following further describes the implementations of this application in detail with reference to the accompanying drawings.

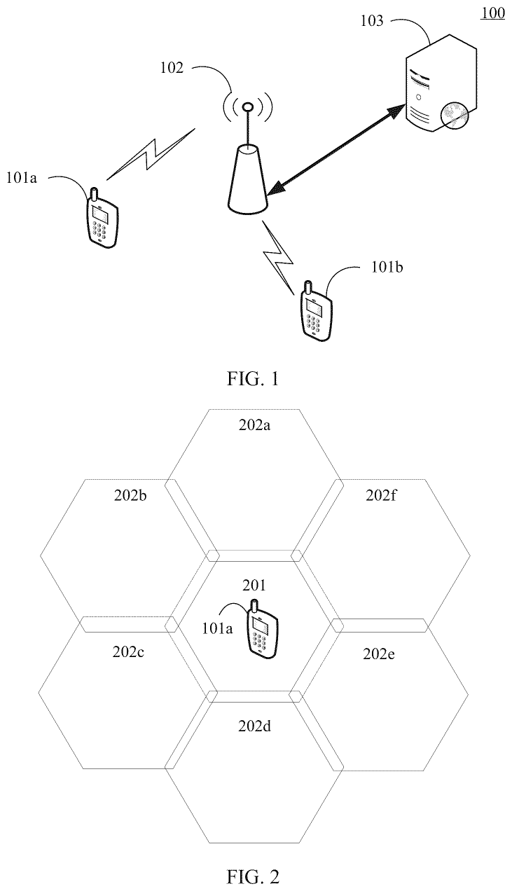

FIG. 1 is a wireless communication network system 100 according to some embodiments of this application. As shown in FIG. 1, the wireless communication network system 100 includes user equipment (User Equipment, UE) 101a and/or UE 101b, a base station 102, an application server 103, and/or another device. The UE 101a and/or the UE 101b is located in a signal coverage area of the base station 102, and maintains a wireless service connection to the base station 102. The UE 101a and/or the UE 101b may be connected to the application server 103 through the base station 102. Therefore, the application server 103 may provide service support for the UE 101a and/or the UE 101b.

Examples of the UE 101a and the UE 101b include, but are not limited to, a portable or mobile device, a mobile phone, a personal digital assistant, a cellular phone, a handheld PC, a wearable device (for example, a smartwatch or a smart band), a portable media player, a handheld device, a navigation device, a server, a network device, a graphics device, a video game device, a set-top box, a laptop device, a virtual reality and/or augmented reality device, an internet of things device, an industrial control device, an intelligent vehicle, a vehicle-mounted infotainment device, a streaming media client device, an e-book, a reading device, a POS terminal, and another device. In some other embodiments, examples of the UE 101a and the UE 101b may further include but are not limited to a wireless router, an in-vehicle communication module, and another device that can connect to the internet by using a wireless communication network. It should be noted that the UE 101a or the UE 101b or both in FIG. 1 indicate possible resource contention between a plurality of user equipments, and are not intended to limit a quantity of devices in the signal coverage area of the base station 102.

The base station 102 is configured to, in accordance with a wireless communication protocol, such as 2G, 3G, 4G, 5G of IEEE 802.11, or other future protocols, provide access to a wireless network for the UE 101a and/or the UE 101b, to support communication between the UE 101a and/or the UE 101b and the application server 103 in the wireless communication network system 100.

The application server 103 generally refers to a server of various applications on a service provider side, and is configured to provide running support for an application running on the UE 101a and/or the UE 101b. A client of the application runs on the UE 101a and/or the UE 101b, and a server of the application runs on the application server 103. After the UE 101a and/or the UE 101b starts the client of the application, the client needs to maintain a communication connection to the server on the application server 103. The UE 101a and the UE 101b communicate with the application server 103 by using the base station 102 (including a wireless network connected to the base station 102), the Internet (not shown), or the like. The communication connection may be wired or wireless connection, and may be via a local area network or a wide area network. For example, in some embodiments, the application server 103 may be a WeChat server. Correspondingly, the application running on the UE 101a and/or the UE 101b is a WeChat program. The application server 103 may be a Huawei video server. Correspondingly, the application running on the UE 101a and/or the UE 101b is a Huawei video program. In some embodiments of this application, lagging occurs in an application (for example. Huawei Video) running on the UE 101a and/or the UE 101b, but the UE 101a or the UE 101b or both display good communication quality. When it is determined that the serving cell in which the UE 101a or the UE 101b or both are located is not congested, the UE 101a or the UE 101b or both send information to the application server 103 to notify the application server 103 that video lagging occurs on the client, and the application server 103 may perform load balancing, to resolve the problem of lagging.

In some use scenarios, a user of the UE 101a and/or the UE 101b in FIG. 1 may feel that an application runs slowly, for example, there is no response to a click, or a video freezes. However, signal strength between the UE 101a and/or the UE 101b and the base station 102 displayed on the UE 101a and/or the UE 101b is full bars. This is possibly because the serving cell (the base station 102) in which the UE 101a or the UE 101b or both are located is already heavily loaded. For example, the base station 102 is processing a request of the UE 101a with full strength, and there is no idle resource to process a service request sent by the UE 101b. This is also possibly because the application server 103 is in excessively heavy load and fails to respond to a request of the UE 101a and/or the UE 101b. The foregoing serving cell is sometimes referred to as a primary cell. In a cellular communication system, the serving cell refers to a cell in which the user equipment is currently located, that is, the serving cell refers to a cell that is providing a communication network connection for the user equipment.

In this case, this application provides a solution. The UE 101a or the UE 101b or both calculate a load rate of a serving cell on which the UE 101a or the UE 101b or both camp, and adjust a service of the UE 101a and/or the UE 101b based on the load rate. The load rate represents resource utilization of a cell. A high load rate indicates that a large amount of cell resources are used, and requests of some user equipments may fail to be processed in time. When the load rate exceeds a predefined cell congestion threshold, the UE 101a or the UE 101b or both initiate a request to hand over the UE 101a and/or the UE 101b to another cell, so that a service of the UE 101a and/or the UE 101b is carried by another cell. The another cell is usually adjacent to the serving cell, and overlaps a signal coverage area of the serving cell. In this application, such a cell is referred to as a neighboring cell.

Usually, when the load rate calculated by the UE 101a and/or the UE 101b does not exceed the cell congestion threshold, it indicates that slow application running may be caused by load imbalance of the application server 103. The UE 101a and/or the UE 101b may notify the application server 103 of this problem (as the example given above in the description of the application server 103), to assist the application server 103 in load balancing. In some other embodiments, a secondary card (for example, another SIM card) of the UE 101a and/or the UE 101b may be switched to a primary card, and a connection to the application server 103 is established by using the new primary card. Switching between the primary/secondary cards may result in changing a communication service operator, user permission, or a service type.

In the wireless communication network system 100 shown in FIG. 1, the UE 101a or the UE 101ba or both implement a connection to the application server 103 through segmented switching between a mobile data network and the Internet. A problem that occurs in any one of the UE 101a and/or the UE 101ba, the mobile data network, the Internet, and the application server 103 may affect communication effect between the UE 101a and/or the UE 101ba and the application server 103. Because the base station 102 serves a plurality of user equipments, such as the UE 101a and the UE 101b, the plurality of user equipments may contend for a communication resource with the base station 102. When the contention is intense to some extent (for example, the load rate exceeds the cell congestion threshold), congestion is determined. In this case, although the signal strength displayed by the user equipment is good, for example, the signal strength icon of the user equipment shows full bars, actual user experience is poor (for example, video lagging and page refreshing failure). In this case, the user equipment may determine whether congestion occurs, and determine subsequent cell handover or secondary card switching according to the result of determining. The foregoing determining-before-switching process clearly identifies a use scenario in which the network speed of the user equipment is low due to congestion of the serving cell, and performing handover (cell handover or primary/secondary card switching) in this scenario is more targeted. Compared with the strategy of blind switching in the conventional technology as long as the network speed is low, causes of the low network speed are distinguished, so that a more targeted strategy can be adopted.

FIG. 2 is a schematic diagram of a cellular network cell (Cell) according to some embodiments of this application. A regular hexagon in the figure represents a cell. In an actual environment, the cell may be in another shape due to impact of terrain, obstacles, and the like. As shown in the figure, cells may overlap each other. Herein, a cell on which the UE 101a camps and that provides a wireless communication service for the UE 101a is referred to as a serving cell. For example, as shown in FIG. 2, the UE 101a is located in a serving cell 201, that is, the UE 101a is currently connected to a wireless communication network through the serving cell 201. A plurality of neighboring cells exist around the serving cell 201, for example, neighboring cells 202a to 202f. Signal coverage areas of these neighboring cells overlap a signal coverage area of the serving cell 201. In actual network deployment, cells of a same operator or cells of different operators usually have an overlapping area of up to ⅓ to ½. Therefore, there is a high probability that the user equipment is located in a place where cells overlap when accessing the Internet. In this case, the UE 101a may choose to access the wireless communication network through the serving cell 201 or a neighboring cell (for example, one of 202a to 202f).

In addition, according to FIG. 2, the UE 101a in the serving cell 201 is also interfered by signals from the neighboring cells 202a to 202f. When the UE 101a or the UE 101ba or both measure pilot signal power (for example, RSRP) or power of a received signal (for example, RSSI), the measured values include power of a signal (energy) of a current cell, and include power of interference caused by a signal of a neighboring cell. In addition, the signal of the current cell further includes a data signal, a pilot signal, and a noise signal. During calculation of a cell load rate, if the power of the interference, the pilot signal power, and the noise signal power are not subtracted from the measured values, accuracy of the load rate is affected. Therefore, in the technical solution provided in this application, the load rate is calculated by dividing the data signal power part in the measured values by the data signal power in the case of full load.

In brief, in this application, existing definition of a load rate of a cell is further detailed as follows:

$$\frac{\begin{matrix}Total reveived signal power - Pilot signal power - Noise \\ signal power - Neighboring cell interference signal power\end{matrix}}{\begin{matrix}Data signal power deduced in the case of \\ full load according to a ratio\end{matrix}} .$$

Pilot signal power and noise signal power are non-data signal power included in total received signal power (for example, RSSI), and neighboring cell interference signal power is a sum of interference from the neighboring cells 202a to f measured by the UE 101a. The data signal power in the case of full load is data signal power when all resource elements (Resource Element, RE) that carry the data signal are used.

Based on different center frequencies of all cells and a time sequence of signals sent in the cells, the neighboring cells may be classified into intra-frequency neighboring cells of the serving cell, inter-frequency neighboring cells of the serving cell, synchronous neighboring cells of the serving cell, and asynchronous neighboring cells of the serving cell. Strengths of interference caused by different types of neighboring cells 202a to 202f to the serving cell 201 are different. In this embodiment provided in this application, different interference caused to the serving cell 201 is further detailed based on an intra-frequency cell, a synchronous cell, or an intra-frequency synchronous cell. The interference is then subtracted separately from the RSSI to obtain the data signal power part in the measured values. In addition, a power value of the data signal in the case of full load of the serving cell 201 may be calculated based on a setting of a ratio of data signal power to pilot signal power in a system configuration of the serving cell 201.

Compared with a conventional technology, the solution for calculating the load rate of the serving cell 201 proposed according to the characteristics of the network structure shown in FIG. 2 considers the interference caused to the serving cell, depending on whether the neighboring cell is a synchronous cell or an intra-frequency cell. In addition, the data signal power is calculated based on the ratio of the data signal power to the pilot signal power configured in the system, eliminating an error caused by non-data signal power and further improving calculation accuracy of the load rate.

Compared with the conventional technology in which the load rate is defined as RSSI/(N×RSRP), the numerator and the denominator in existing definition are respectively modified in the foregoing formula. For the numerator, the pilot signal power and the noise signal power included in the RSSI and the power of the interference caused by the signal of the neighboring cell are subtracted from the RSSI, and the data signal power part included in the measured signal power remains. For the denominator, (N×RSRP) is not directly used as the data signal power (denominator) in the case of full load. Instead, the data signal power in the case of full load is deduced based on a probability of synchronization/asynchronization and a ratio of data signal energy to pilot signal energy specified in the system configuration. In this application, a more accurate load rate is obtained by modifying an existing load rate formula, thereby providing a more reliable basis for accurately determining whether a cell is congested.

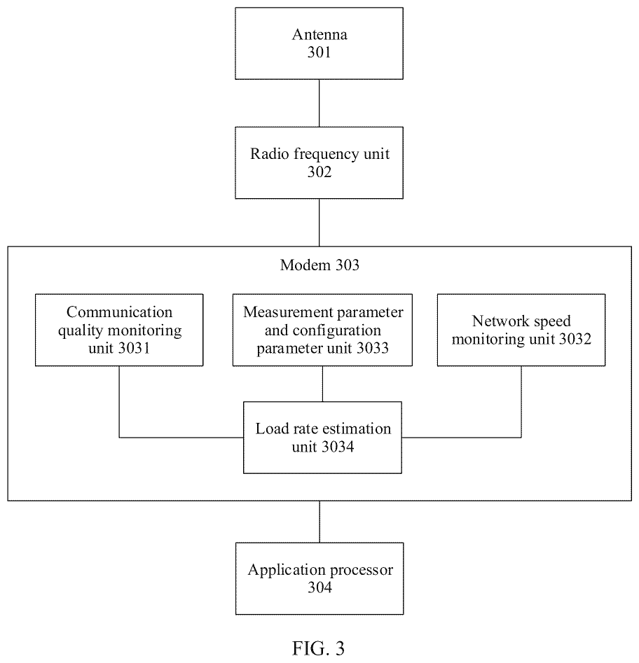

FIG. 3 is a schematic diagram of user equipment (for example, the UE 101a) that includes a functional unit used for cell load rate estimation according to some embodiments of this application. FIG. 3 is a schematic diagram in which a load rate estimation unit 3034 is disposed in a modem 303. A person skilled in the art should understand that the load rate estimation unit 3034 may also be disposed in another component of the UE 101a and/or the UE 101b. For example, the load rate estimation unit 3034 may be disposed in an application processor 304. Similarly, obtaining (measurement) of measurement parameters in a network speed monitoring unit 3032 and/or a measurement parameter and configuration parameter unit 3033 is not necessarily limited to the modem 303. For example, in some embodiments, the network speed monitoring unit 3032 may be disposed in a dedicated network management module (not shown).

Specifically, an antenna 301 shown in FIG. 3 is an antenna of the UE 101a and/or the UE 101b. The antenna 301 may be one of a plurality of antennas of the UE 101a and/or the UE 101b, and configured to transmit and receive a radio signal (radio frequency signal) between the UE 101a and/or the UE 101b and the base station 102. The following uses signal receiving (a downlink of a cellular network) as an example to describe the block diagram shown in FIG. 3. After the antenna 301 receives a radio frequency signal transmitted by the base station 102, a radio frequency unit 302 converts the radio frequency signal into a baseband signal, and inputs the baseband signal to the modem 303. The modem 303 usually includes a decoder (not shown) that can demodulate the foregoing baseband signal. In this embodiment, the modem 303 further includes a communication quality monitoring unit 3031, the measurement parameter and configuration parameter unit 3033, the network speed monitoring unit 3032, and the load rate estimation unit 3034.

The communication quality monitoring unit 3031 is configured to monitor at least one

of pilot signal received power (Reference Signal Received Power, RSRP), pilot signal received quality (Reference Signal Received Quality, RSRQ), and a signal to interference plus noise ratio (Signal to Interference plus Noise Ratio, SINR). The RSRP, the RSRQ, and the SINR are parameters indicating signal quality of a signal received by the user equipment. When a value of any one of the parameters is less than a preset quality threshold, current communication quality between the UE 101a and/or the UE 101b and the base station 102 is considered to be poor. Otherwise, the communication quality is considered to be qualified (good). In some other embodiments, attentions may further be paid to another indicator representing communication quality, for example, a bit error rate. Details are not described herein again.

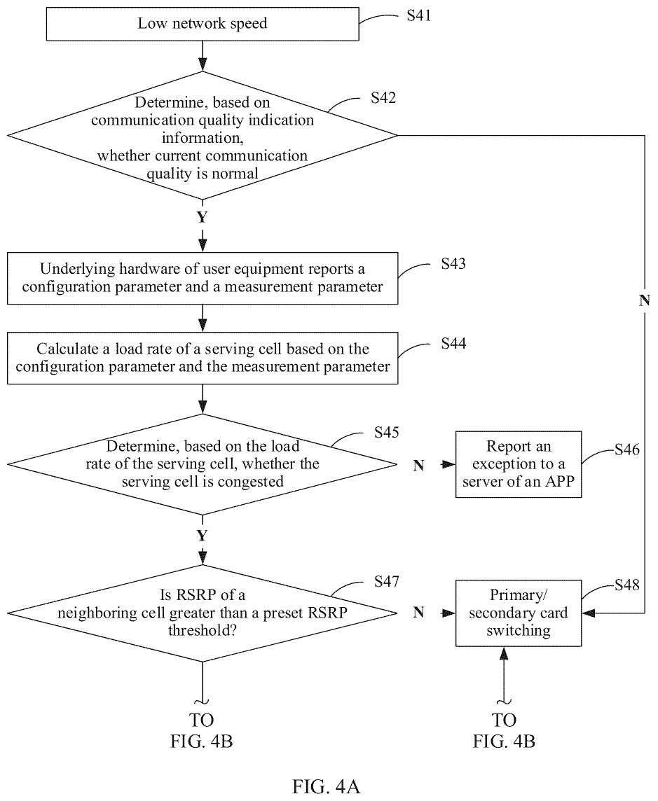

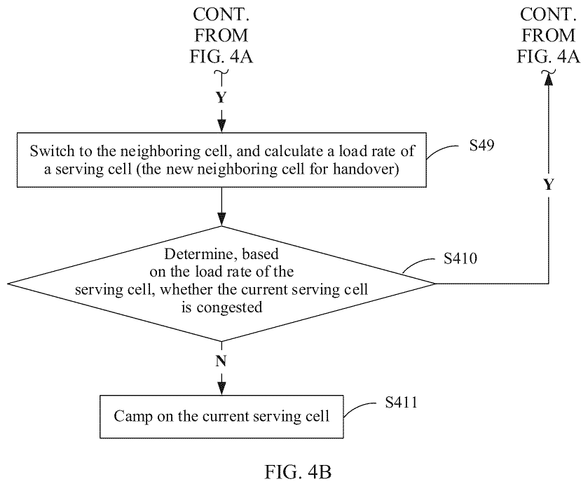

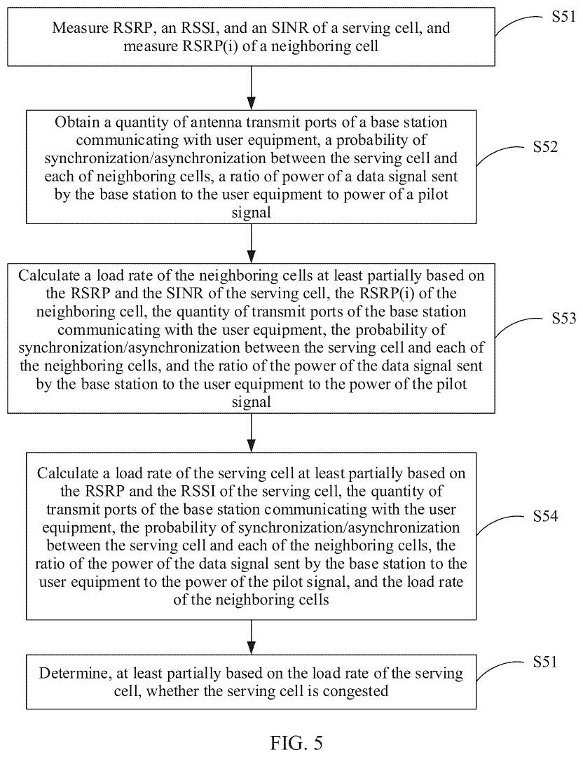

The measurement parameter and configuration parameter unit 3033 provides the load rate estimation 304 with various parameters required for calculating the load rate. The parameters include at least: a received signal strength indicator (Received Signal Strength Indicator, RSSI) and RSRP of the serving cell 201 in which the UE 101a and/or the UE 101b is located, a quantity of antenna transmit ports of the base station 102 communicating with the UE 101a and/or the UE 101b, a probability of asynchronization (asynchronization) P(A) between the serving cell 201 of the UE 101a and/or the UE 101b and each of the neighboring cells 202a to 202f, a probability of synchronization P(B) between the serving cell 201 and each of the neighboring cells 202a to 202f, and ratios (ρ_{A} and ρ_{B}) of power of a data signal sent by the base station 102 to power of a pilot signal sent by the base station 102, and a quantity N of RBs (Resource Block, resource block) in total bandwidth of the serving cell 201. For details about how to use these parameters, refer to the following descriptions related to FIG. 4A and FIG. 4B and FIG. 5, especially FIG. 5. It should be noted that in this embodiment, the measurement parameter and configuration parameter unit 3033 is not required to be the first functional unit that measures or calculates the foregoing parameters, and the measurement parameter and configuration parameter unit 3033 may only collect and gather the foregoing parameters, to send them to the load rate estimation unit 3034 through a unified interface.

The network speed monitoring unit 3032 monitors a network speed of the UE 101a and/or the UE 101b in real time, and gives a prompt message when the network speed is less than a preset network speed threshold. The prompt information may be used as one of the conditions for triggering the load rate estimation 3034 to calculate the cell load rate.

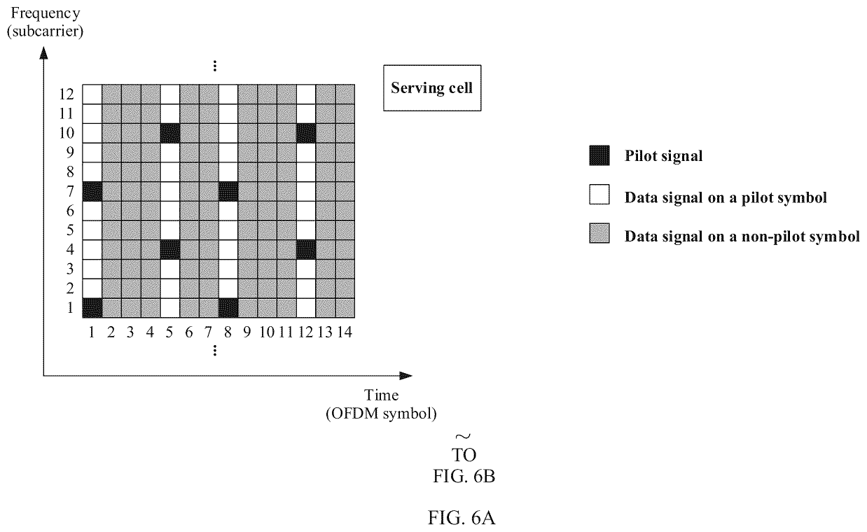

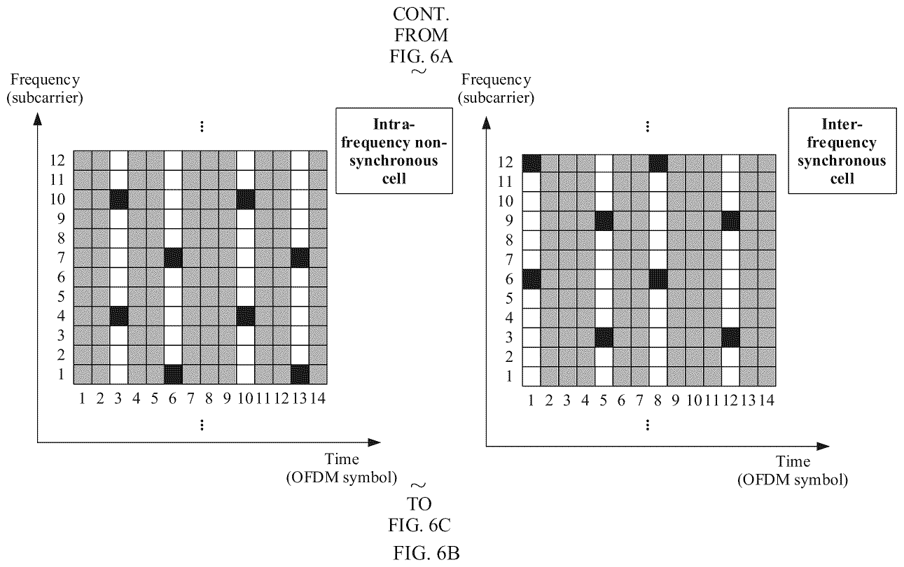

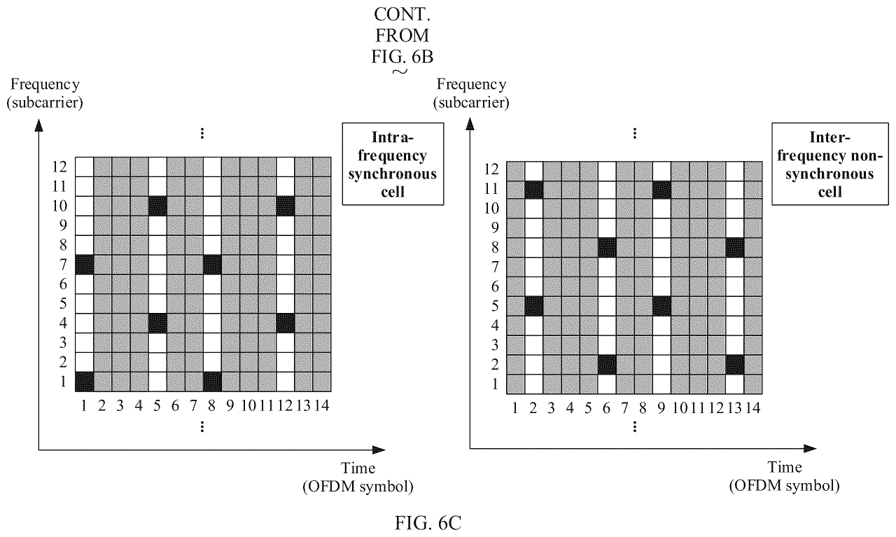

After receiving a message from the communication quality monitoring unit 3031 indicating that the communication quality is qualified and a message from the network speed monitoring unit 3032 indicating that the network speed is low, the load rate estimation unit 3034 starts to calculate the load rate of the serving cell 201. For a specific example of load rate calculation, refer to subsequent descriptions related to FIG. 5 and FIG. 6A to FIG. 6C. In some embodiments, the load rate estimation unit 3034 reports the load rate to the application processor 304. The application processor 304 determines a subsequent step based on the load rate. In some other embodiments, the load rate estimation unit 3034 may alternatively directly determine a subsequent step based on the load rate.

In the embodiment shown in FIG. 3, when the signal quality is good but the network speed is low, the application processor 304 of the UE 101a and/or the UE 101b may not directly switch between cells or primary/secondary cards first. Instead, it is first analyzed whether the base station 102 fails to respond to various requests sent by the UE 101a and/or the UE 101b due to a high load rate of the serving cell 201 (that is, whether cell congestion occurs). When it is determined that the foregoing case is caused by congestion of the serving cell, the application processor 304 may decide to improve communication quality of the UE 101a and/or the UE 101b through cell handover or primary/secondary card switching. When it is determined that the foregoing case is not caused by congestion of the serving cell, the application processor 304 may decide to improve communication quality of the UE 101a and/or the UE 101b by notifying the application server 103 to adjust a load balancing state of the server. Such targeted processing strategies can more effectively improve the low network speed.

FIG. 4A and FIG. 4B are a flowchart of estimating a cell load rate and adjusting a communication service based on the cell load rate according to some embodiments of this application.

In S41, the network speed monitoring unit 3032 detects that the network speed is low. As described above, the network speed monitoring unit 3032 monitors the network speed of the UE 101a and/or the UE 101b in real time. When the detected network speed is less than a preset network speed threshold, for example, in a text chat application, the preset network speed threshold may be 1 kbps. When the detected network speed is less than 1 kbps, it may be properly deduced that lagging or slow running occurs in the current text chat application. In a video playing application, the preset threshold may be 5 Mbps. When the detected network speed is less than 5 Mbps, it may be properly deduced that the current video playing application experiences lagging, slow running, slow page refreshing, or the like. Therefore, in this embodiment, the information about the low network speed is sent to the load rate estimation unit 3034, so that the load rate estimation unit 3034 determines whether to start load rate calculation.

In S42, the communication quality monitoring unit 3031 may compare communication quality indication information with the communication quality threshold to determine whether the communication quality of the UE 101a and/or the UE 101b is normal. The communication quality indication information may include RSRP, RSRQ, SINR, and the like. In some embodiments, the communication quality monitoring unit 3031 may compare measured values of the RSRP, the RSRQ, and the SINR with corresponding signal quality thresholds to determine whether the communication quality of the UE 101a and/or the UE 101b is normal. For example, the measured value of the RSRP is compared with the RSRP threshold. If the measured value of the RSRP is greater than the RSRP threshold, it indicates that communication quality of the UE 101a and/or the UE 101b is normal, and vice versa. When the communication quality monitoring unit 3031 determines that the communication quality of the UE 101a and/or the UE 101b is abnormal, S48 of primary/secondary card switching may be performed. That is, when the network speed is slow and the signal quality is poor, a service provider providing the communication service may be directly changed, or user permission or a service type may be changed. However, when the communication quality monitoring unit 3031 determines that the communication quality of the UE 101a and/or the UE 101b is normal but the network speed is not fast (that is, the network speed detected by the network speed monitoring 3032 is less than the preset network speed threshold), the UE 101a and/or the UE 101b may perform the step of calculating the load rate of the serving cell 201, and further determine, based on a value of the load rate, whether to perform cell handover, primary/secondary card switching, or report an exception to the application server 103. In some other embodiments, one or two of the RSRP, the RSRQ, and the SINR may be separately monitored, and whether communication quality is normal is determined based on whether the value thereof exceeds a corresponding quality threshold.

After the two prerequisites of a low network speed and normal communication quality are met, S43 is performed to start the procedure of load rate calculation. In S43, the measurement parameter and configuration parameter unit 3033 obtains various parameters required for calculating the load rate. As described above, the various parameters include parameters measured by underlying hardware (such as a processing unit at a physical layer) of the UE 101a and/or the UE 101b, for example, RSRP (RSRP of a serving cell and RSRP of a neighboring cell) and an RSSI, and further include configuration parameters of a communication system provided by a network side (for example, the base station 102), for example, a probability of asynchronization (asynchronization) P(A) and a probability of synchronization P(B), ratios (ρ_{A} and ρ_{B}) of data power to pilot power, and a quantity of antenna transmit ports of the base station. ρ_{A} and ρ_{B} are ratios of data power to pilot power on a resource element (Resource Element, RE), that is, ratios of data signal power to pilot signal power. The subscript “A” represents data signal power of an RE on a non-pilot symbol. Definition of ρ_{B} is similar to that of ρ_{A}, and a difference lies in that the subscript “B” indicates that the data power is data power of an RE on a pilot symbol. In addition, the concepts of synchronization and asynchronization, and the concepts of the pilot symbol and non-pilot symbol described above may be described with reference to FIG. 5 and FIG. 6A to FIG. 6C. The foregoing underlying hardware generally refers to various hardware units that work at an underlying layer. The underlying layer is a concept from a protocol layer of an LTE system. In brief, the LTE system divides a data processing process into three protocol layers: a physical layer (layer L1), a data link layer (layer L2), and a network layer (layer L3). Processing units at the physical layer and the data link layer complete basic information processing and transmission functions, which are “underlying layer” work in the LTE system. Therefore, the physical layer and the data link layer are usually collectively referred to as the underlying layer. Hardware units at the physical layer and the data link layer are correspondingly referred to as underlying hardware.

In S44, the load rate of the serving cell is calculated based on the plurality of parameters provided by the measurement parameter and configuration parameter unit 3033. The plurality of parameters include at least one of the RSSI, the RSRP, the quantity of antenna transmit ports of the base station 102 communicating with the UE 101a and/or the UE 101b, the probability of asynchronization (asynchronization) P(A) between the serving cell 201 of the UE 101a and/or UE 101b and each of the neighboring cells 202a to 202f, the probability of synchronization P(B) between the serving cell 201 and each of the neighboring cells 202a to 202f, ratios (ρ_{A} and ρ_{B}) of the power of the data signal sent by the base station 102 to the UE 101a and/or UE 101b to the power of the pilot signal sent by the base station 102 to the UE 101a and/or UE 101b. Specifically, an average load rate of the neighboring cells 201a to 201f may be first calculated based on some parameters in the foregoing parameters, and then the load rate of the serving cell 201 is calculated based on some parameters in the foregoing parameters and the load rates of the neighboring cells. The purpose of calculating the load rate of the neighboring cells is to subtract the interference caused by the data signal power of the neighboring cell to the serving cell from the received signal power monitored by the serving cell. In this application, the noise refers to impact caused by an inherent small-amplitude signal in entire frequency domain caused by an environment (including a natural environment and a working environment) on a target signal, for example, background noise (Background Noise) and white noise that are frequently mentioned. This type of noise can usually be suppressed, but not eliminated. The interference refers to impact of electromagnetic signals transmitted by people on the target signal. Intensity of such interference is much greater than that of the foregoing noise. However, such interference disappears as long as the transmission is stopped. For example, signal power generated by the UE 101a in a call process may cause interference to the call of the UE 101b. However, as long as the UE 101a stops the call, the UE 101b no longer receives interference from the UE 101a. In addition, this type of interference occurs only in a specific frequency band. The interference can be eliminated as long as the corresponding frequency band is avoided. In this application, interference caused by a signal of a neighboring cell to a signal of a serving cell is referred to as signal interference, and interference caused by a data signal of a neighboring cell to a signal of a serving cell is referred to as data interference.

An ideal load rate calculation formula should be:

$$\frac{Used data signal power}{Data signal power in the case of full load} .$$

However, when parameters such as the RSRP and the RSSI are measured, signal power actually measured may include power of a data signal, power of a pilot signal, power of noise, and power of interference. Capacity of data power on an RE (that is, data signal power in the case of full load) may be converted based on configuration parameters such as the RSRP, the quantity of antenna transmit ports, and the energy ratios (ρ_{A} and ρ_{B}). For a specific example of calculation, refer to the description of FIG. 5 and FIG. 6A to FIG. 6C. “Data signal power in the case of full load” herein may refer to data signal power when all REs carrying data signals are used.

In S45, the UE 101a or the UE 101b or both determine, based on the calculated load rate of the serving cell 201 and a cell congestion threshold, whether the serving cell 201 is congested. For example, when the load rate exceeds the preset cell congestion threshold, it is determined that the serving cell 201 is congested, and then S47 and subsequent steps may be performed. Otherwise, it is determined that the serving cell 201 is not congested, and then S46 is performed. If the serving cell 201 is not congested, cell/secondary card switching cannot resolve the problem of a low network speed of the UE 101a and/or the UE 101b, and the current low network speed of the UE 101a and/or the UE 101b is fed back to the corresponding application server 103 (associated with the current active application of the UE 101a and/or the UE 101b), to prompt the application server 103 to improve an operating environment of the application server 103, for example, load balancing (S46). If the serving cell 201 is congested, cell handover or primary/secondary card switching may be considered.

In order to further determine cell handover or primary/secondary card switching, and select a neighboring cell for cell handover, S47 may be performed. In S47, it is determined whether the RSRP(i) of each neighboring cell is greater than a preset RSRP threshold, where i represents a number of the neighboring cell. When the RSRP(i) of the neighboring cell is greater than the RSRP threshold, it indicates that signal quality (which may also be understood as communication quality) of the neighboring cell is good, and switching of the UE 101a and/or the UE 101b to the neighboring cell may be considered. If the RSRP(i) of the neighboring cell is less than the RSRP threshold, it indicates that communication quality of the neighboring cell is not good, and handover of the UE 101a and/or the UE 101b to the neighboring cell may not be considered. If the RSRP(i) of all neighboring cells is less than the RSRP threshold, primary/secondary card switching may be considered (S48). The secondary card in the UE 101a and/or the UE 101b is switched to the primary card, and communication is performed by using the new primary card. When RSRP(i) of a plurality of neighboring cells is greater than the RSRP threshold, a neighboring cell with the largest RSRP(i) in them may be selected, or a neighboring cell on a moving path of the UE 101a and/or the UE 101b may be selected as a target cell for handover.

In S49, after the UE 101a or the UE 101b or both are handed over to a new serving cell (for example, the original neighboring cell 202a), a load rate of the new serving cell is first calculated (that is, the load rate of the original neighboring cell 202a is calculated). The calculation method is shown in S43 to S47. A difference lies in that the serving cell in the current calculation process is one of the neighboring cells in the previous calculation process, and the serving cell 201 in the previous calculation process turns into one of the neighboring cells in the current calculation process. In addition, neighboring cells in the two calculation processes may not be completely the same. That is, after the neighboring cell 202a serves as a new serving cell, neighboring cells related to the new serving cell may not be the original neighboring cells 202b to f and the original serving cell 201.

S410 is used to determine whether the UE 101a or the UE 101b or both camp on the new serving cell. In S410, based on the load rate calculated in S49 and the cell congestion threshold, it is determined whether the current serving cell (the new serving cell) is congested, that is, when the load rate is greater than the cell congestion threshold, it is considered that the current serving cell is congested. Otherwise, it is considered that congestion does not occur. If the current serving cell is also in a congested state, it indicates that the current serving cell cannot improve the communication environment of the UE 101a and/or the UE 101b, and the UE 101a and/or the UE 101b may choose primary/secondary card switching (S48). Alternatively, based on the case in S47 in which the RSRP(i) of a plurality of neighboring cells is greater than the RSRP threshold, the UE 101a and/or the UE 101b may also select/traverse other neighboring cells whose RSRP(i) is greater than the RSRP threshold to choose whether to hand over to the other neighboring cells, for example, the original neighboring cells 202b to f. In the case of re-selecting a neighboring cell for handover, S49 and S10 are repeated to determine whether to camp on the new serving cell. In S410, if the current serving cell is not congested, the UE 101a and/or the UE 101b may camp on the new serving cell (the current serving cell) (S411).

In the embodiment shown in FIG. 4A and FIG. 4B, before cell handover or primary/secondary card switching, the load rate of the serving cell is calculated, reducing blindness of switching. In a conventional technology, cell handover or primary/secondary card switching is usually determined after two indicators, namely, a low network speed and good communication quality, are detected. However, the network speed is low but the communication quality is good not for only one reason. Congestion may occur in communication between the UE 101a and/or the UE 101b and the base station 102, or the server 103 of the application running on the UE 101a and/or the UE 101b is faulty and fails to respond to a request sent by the application in time. The low network speed caused by these two reasons cannot be resolved through a unified method. For example, simple cell handover or primary/secondary card switching in a conventional technology cannot resolve the problem on the side of the application server 103. On the contrary, the act of switching wastes resources of the communication system (for example, the base station 102). From the perspective of the application server 103, it is possible that the application server 103 is unaware that the problem has occurred. In this application, whether congestion occurs in the serving cell 201 is determined by calculating the load rate. If congestion occurs, it indicates that a low network speed is probably caused by poor communication between the UE 101a and/or the UE 101b and the base station 102. Therefore, the problem can be resolved through cell handover or primary/secondary card switching. However, if the serving cell 201 is not congested (for example, the load rate does not exceed the cell congestion threshold), the switching/handover cannot resolve the problem. The problem encountered by the application client should be fed back to the application server, so that the server resolves the problem of response, thereby improving user experience.

The calculation of the load rate is described below with reference to FIG. 5 and FIG. 6A to FIG. 6C. FIG. 5 is a flowchart of a method for estimating a load rate of a serving cell in which user equipment is located according to some embodiments of this application. FIG. 6A to FIG. 6C are a comparison diagram of resource blocks (Resource Block, RB) in a serving cell and each of neighboring cells, where each of the neighboring cells is adjacent to the serving cell, and more specifically, are a comparison of distribution diagrams of signals carried by all resource elements (Resource Element, RE) in the RB. An RB is a basic unit for resource scheduling in an LTE system. Based on different configurations, the RB occupies a fixed length in both time domain and frequency domain, as shown by a large block in FIG. 6A to FIG. 6C. FIG. 6A to FIG. 6C show one RB. In an actual data transmission process, as time progresses, there are a plurality of consecutive RBs on a time axis (horizontal coordinate). In addition, based on different carriers (subcarriers) used for signal transmission, there are a plurality of RBs on a frequency axis (vertical coordinate). An RE is the smallest resource element in an LTE system. During resource mapping at a physical layer, an RE is used as a basic unit. An RE occupies a width of an OFDM (Orthogonal Frequency Division Multiplexing, orthogonal frequency division multiplexing) symbol on the time axis and a width of a subcarrier on the frequency axis. In FIG. 6A to FIG. 6C, a small grid represents an RE. It can be learned from the figure that one RB includes a plurality of REs. In a currently used configuration, an RB usually includes 12 (OFDM symbol)×12 (subband) or 14 (OFDM symbol)×12 (subband) REs in size, and the latter is shown in FIG. 6A to FIG. 6C.

FIG. 6A to FIG. 6C are further explained. In the coordinate diagram, the horizontal coordinate is the time axis, and the vertical coordinate is the frequency axis. A small grid shown in the figure represents an RE, and three colors, black, white, and gray, indicate a type of a signal carried on the RE. A large block containing small grids colored as black, white, and gray represents an RB. The horizontal coordinate of each small grid is an OFDM symbol (OFDM Symbol), and the vertical coordinate is the width of a subcarrier. According to 3GPP (3rd Generation Partnership Project, 3rd Generation Partnership Project) specifications, an RB (for example, LTE downlink) is the smallest unit allocated to a user in downlink wireless communication (for example, 4G, 5G, 6G, and the like). For example, resources that can be allocated to a user in an LTE downlink include a frequency domain resource, a time domain resource, and a space domain resource, that is, there are frequency division multiplexing, time division multiplexing, and space division multiplexing. Space domain resource allocation is implemented by using MIMO (Multiple-input Multiple-output, multiple-input multiple-output). According to existing 3GPP (3rd Generation Partnership Project, 3rd Generation Partnership Project) specifications, the RB may be a combination of resources including 12 subcarriers (frequency domain) and lasting for one slot (time domain). According to some 3GPP network configurations, one slot may be 0.5 ms in length. In 0.5 ms (one slot), a plurality of OFDM symbols can be generated in the LTE downlink, and each symbol occupies 12 subcarriers. An RB includes a plurality of REs. An RE is a combination of resources including one subcarrier (frequency domain) and lasting for one OFDM symbol (time domain). As shown in FIG. 6A to FIG. 6C, duration of one RB is one slot, and one slot may be divided into a plurality of OFDM symbols. According to the embodiment shown in FIG. 6A to FIG. 6C, although one RB includes 12 subcarriers and one slot is divided into 14 OFDM symbols, a person skilled in the art should understand that a quantity of subcarriers included in one RB, duration occupied by one slot, and a quantity of OFDM symbols included in one slot may be determined by configuration at a network end. In addition, in the following description, for brevity, an OFDM symbol on which a pilot signal appears is referred to as a pilot symbol (for example, in the RB diagram of the serving cell in FIG. 6A to FIG. 6C, OFDM symbols numbered 1, 5, 8, and 12 on the time axis are referred to as pilot symbols), and an OFDM symbol on which no pilot signal appears is referred to as a non-pilot symbol (for example, in the RB diagram of the serving cell in FIG. 6A to FIG. 6C, OFDM symbols numbered 2, 3, 4, 6, 7, 9, 10, 11, 13, and 14 on the time axis are referred to as non-pilot symbols). According to the foregoing definition, signal types respectively carried by REs of the three colors black, white, and gray in FIG. 6A to FIG. 6C are explained. The black RE carries a pilot signal, the white RE carries a data signal on a pilot symbol, and the gray RE carries a data signal on a non-pilot symbol. According to 3GPP specifications, the pilot signal may include a signal transmitted by a network side device (for example, the base station 102) in a wireless network to the UE 101a and/or the UE 101b for measurement or monitoring purposes.

Although only one RB is shown in FIG. 6A to FIG. 6C, actually, a plurality of RBs may be superimposed on the horizontal axis (time domain) and the vertical axis (frequency domain). In other words, the RBs may extend on the horizontal axis and the vertical axis. An extension range of an RB on the vertical axis is limited by total bandwidth of a cell in which the RB is located. Total bandwidth of a cell may be a difference between a maximum frequency and a minimum frequency generated after a plurality of RBs are superimposed on the vertical axis (frequency domain).

FIG. 6A to FIG. 6C show a comparison diagram of RBs of a serving cell, an intra-frequency asynchronous neighboring cell, an inter-frequency synchronous neighboring cell, an intra-frequency synchronous neighboring cell, and an inter-frequency asynchronous neighboring cell, respectively.

Intra-frequency asynchronous cells refer to two or more cells in which pilot signals appear on a same subcarrier (that is, same vertical coordinate) but different OFDM symbols (that is, different horizontal coordinates). For example, in the coordinate diagram of the serving cell and the intra-frequency asynchronous neighboring cell shown in FIG. 6A to FIG. 6C, pilot signals (small black grids) on OFDM symbols 1, 5, 8, and 12 in the RB of the serving cell appear on subcarriers 1, 4, 7, and 10, and pilot signals on OFDM symbols 3, 6, 10, and 13 in the intra-frequency asynchronous neighboring cell also appear on subcarriers 1, 4, 7, and 10. Herein, REs that span one OFDM symbol on the horizontal axis and 12 subcarriers on the vertical axis may collectively be referred to as a resource slice. Then, a resource slice in the RB of the serving cell (for example, 12 REs on the OFDM symbol 1) and a resource slice in the RB of the intra-frequency asynchronous cell (that is, 12 REs on the OFDM symbol 6) are the same in frequency domain, but deviated in time domain, that is, are intra-frequency asynchronous.

Inter-frequency synchronous cells refer to two or more cells in which pilot signals appear on different subcarriers (that is, different vertical coordinates) but a same OFDM symbol (that is, same horizontal coordinate). For example, in the coordinate diagram of the serving cell and the inter-frequency synchronous neighboring cell shown in FIG. 6A to FIG. 6C, pilot signals (small black grids) on OFDM symbols 1, 5, 8, and 12 in the RB of the serving cell appear on subcarriers 1, 4, 7, and 10, but pilot signals on OFDM symbols 1, 5, 8, and 12 in the inter-frequency synchronous neighboring cell appear on subcarriers 3, 6, 9, and 12. Then, a resource slice in the RB of the serving cell (for example, 12 REs on the OFDM symbol 1) and a resource slice in the RB of the inter-frequency synchronous cell (that is, 12 REs on the OFDM symbol 1) are the same in time domain, but deviated in frequency domain, that is, are inter-frequency synchronous.

Intra-frequency synchronous cells refer to two or more cells in which pilot signals appear on a same subcarrier (that is, same vertical coordinate) and a same OFDM symbol (that is, same horizontal coordinate). For example, in the coordinate diagram of the serving cell and the intra-frequency synchronous neighboring cell shown in FIG. 6A to FIG. 6C, pilot signals (small black grids) on OFDM symbols 1, 5, 8, and 12 in the RB of the serving cell appear on subcarriers 1, 4, 7, and 10, and pilot signals on OFDM symbols 1, 5, 8, and 12 in the intra-frequency synchronous neighboring cell also appear on subcarriers 1, 4, 7, and 10. Then, a resource slice in the RB of the serving cell (for example, 12 REs on the OFDM symbol 1) and a resource slice in the RB of the inter-frequency synchronous cell (that is, 12 REs on the OFDM symbol 1) are the same in time domain, and the same in frequency domain, that is, are intra-frequency synchronous.

Inter-frequency asynchronous cells refer to two or more cells in which pilot signals appear on different subcarriers (that is, different vertical coordinates) and different OFDM symbols (that is, different horizontal coordinates). For example, in the coordinate diagram of the serving cell and the inter-frequency asynchronous neighboring cell shown in FIG. 6A to FIG. 6C, pilot signals (small black grids) on OFDM symbols 1, 5, 8, and 12 in the RB of the serving cell appear on subcarriers 1, 4, 7, and 10, but pilot signals on OFDM symbols 2, 6, 9, and 13 in the inter-frequency asynchronous neighboring cell appear on subcarriers 2, 5, 9, and 11. Then, a resource slice in the RB of the serving cell (for example, 12 REs on the OFDM symbol 1) and a resource slice in the RB of the inter-frequency synchronous cell (that is, 12 REs on the OFDM symbol 1) are different in time domain, and different in frequency domain, that is, are inter-frequency asynchronous.

As shown in FIG. 5, in some embodiments of the present invention, S51 is first performed. Pilot signal received power (Reference Signal Received Power, RSRP), a received signal strength indicator (Received Signal Strength Indicator, RSSI), and a signal to interference plus noise ratio (Signal to Interference plus Noise Ratio, SINR) of a serving cell (for example, the cell 201) are obtained through measurement by underlying hardware of user equipment (for example, the UE 101a). RSRP(i) of an i^{th} neighboring cell (for example, the neighboring cell 202a) is obtained through message broadcast in the wireless communication network system 100. For the foregoing description of the measurement by the underlying hardware, refer to the description of step S43.

According to the cellular system shown in FIG. 2, there are usually a plurality of neighboring cells around one serving cell 201. In some embodiments of this application, i may represent a number of a cell, where i=0 represents a serving cell, and i=1, 2, 3 . . . respectively represent a first neighboring cell, a second neighboring cell, a third neighboring cell, . . . . This also corresponds to the neighboring cells 202a to 202f in FIG. 1. The foregoing measured parameter (for example, the RSSI) related to signal strength represents actual signal strength currently received by the UE 101a and/or the UE 101b, where the signal may include data, noise, and interference. Therefore, strength of the data signal in the current serving cell 201 may be obtained by performing the following analysis and calculation on the signal strength, to further obtain the load rate of the serving cell.

In S52, a quantity n of antenna transmit ports of a base station (for example, the base station 102) communicating with the UE 101a and/or the UE 101b, a probability of asynchronization P(A) and a probability of synchronization P(B) between the serving cell 201 and each of the neighboring cells 202a to f, ratios (ρ_{A} and ρ_{B}) of data signal power to pilot signal power sent by the base station 102, and a quantity N of RBs in total cell bandwidth are obtained based on a broadcast message of the wireless communication network system 100 or configuration information on the user equipment side. According to some embodiments of this application, the UE 101a and/or the UE 101b may obtain the quantity n of antenna transmit ports, the ratios ρ_{A} and ρ_{B}, and the quantity N of RBs by using a system message (System Information Block, SIB) sent by the base station 102. The UE 101a and/or the UE 101b may set the probability of asynchronization P(A) and the probability of synchronization P(B). For example, refer to the schematic diagram shown in FIG. 6A to FIG. 6C. When a pilot symbol in a neighboring cell overlaps a pilot symbol in the serving cell 201 (that is, they are the same in time domain), the neighboring cell is synchronous with the serving cell, and may be referred to as a synchronous neighboring cell. On the contrary, when a pilot symbol in a neighboring cell does not overlap a pilot symbol in the serving cell 201 (that is, they are different in time domain), the neighboring cell is not synchronous with the serving cell, and may be referred to as an asynchronous neighboring cell. As mentioned above, synchronous neighboring cells may be classified into intra-frequency synchronous neighboring cells and inter-frequency synchronous neighboring cells, and asynchronous neighboring cells may be classified into intra-frequency asynchronous neighboring cells and inter-frequency asynchronous neighboring cells.

According to some embodiments of this application, an RB shown in FIG. 6A to FIG. 6C includes 14 OFDM symbols, where four OFDM symbols are pilot symbols, and the remaining 10 OFDM symbols are non-pilot symbols. In this case, the probability of synchronization P(A) between a neighboring cell and the serving cell may be 4/14(=2/7), and the probability of asynchronization P(B) between a neighboring cell and the serving cell may be 10/14 (=5/7). However, a person skilled in the art should understand that the probability of synchronization and the probability of asynchronization may vary with a total quantity of OFDM symbols, a quantity of pilot symbols, and a quantity of non-pilot symbols included in one RB. An existing common probability of synchronization P(A) and an existing probability of asynchronization P(B) include 0 and 1, 1 and 0, or 4/7 and 3/7. For another example. using one RE as a unit, pilot signal power carried by one RE (pilot signal power represented by a small black grid in FIG. 6A to FIG. 6C) can usually be measured, that is, RSRP. Then, based on the configuration parameters ρ_{A} and ρ_{B} of the system (ratio of data signal power to pilot signal power sent by the base station), data signal power carried in one RE may be calculated. ρ_{A} represents a ratio of data signal power (energy) on an RE on a non-pilot symbol (that is, data signal power carried on a gray grid RE) to pilot signal power (energy), and ρ_{B} represents a ratio of data signal power (energy) on an RE on pilot symbol (that is, data signal power carried on a white grid RE) to pilot signal power (energy). Accordingly, data signal power on a pilot symbol represented by a small white grid in FIG. 6A to FIG. 6C is equal to RSRP×ρ_{A}. Data signal power on a non-pilot symbol represented by a small gray grid is equal to RSRP×ρ_{B}.

According to some embodiments of this application, ρ_{B}/ρₐ may vary with the quantity of antenna transmit ports of the base station 102. For details, refer to Table 2.

TABLE 2
Relationship between antenna ports and ρ_{B}/ρ_{A}

ρ_{B}/ρ_{A}

| p-b | One antenna port | Two or four antenna ports |
|---|---|---|
| 0 | 1 | 5/4 |
| 1 | 4/5 | 1 |
| 2 | 3/5 | 3/4 |
| 3 | 2/5 | 1/2 |

In the table above, a value of ρ_{A} is determined by a configuration parameter p-a of the base station, and a value of ρ_{B} may be calculated according to Table 2. p-a and p-b are configuration information of a base station obtained based on a cell broadcast message, and are power-related parameters. An LTE system adjusts power by configuring p-a and p-b. Values of p-a and p-b are delivered by using signaling sent by the base station 102. Currently, a recommended configuration is p-a=3 dB and p-b=1. When there are two antenna ports, ρ_{A}=p-a. In this case, according to Table 2, the value of ρ_{B} is also −3 dB, that is, on a pilot symbol, pilot power accounts for 1/3.

In S53, a load rate L_{N} of neighboring cells is first calculated. According to some embodiments of this application, the load rate L_{N} herein may be an average load rate of all neighboring cells of the serving cell. As mentioned above, a neighboring cell (for example, each of the neighboring cells 202a to 202f in FIG. 2) is a cellular cell that is adjacent to the serving cell and overlaps the serving cell in terms of signal coverage areas. That is, a signal transmitted by a neighboring cell may be received by the UE 101a in the serving cell. The signal received by the UE 101a from the neighboring cell is referred to as interference. The UE 101a detects interference based on a pilot signal (for example, a pilot signal carried on an RE of pilot symbol 1×subcarrier 1). Therefore, the interference may include a pilot signal from an intra-frequency synchronous neighboring cell (for example, a pilot signal carried on an RE of pilot symbol 1×subcarrier 1 of the intra-frequency synchronous neighboring cell), a data signal from an asynchronous neighboring cell (including an intra-frequency asynchronous neighboring cell and an inter-frequency asynchronous neighboring cell) on a non-pilot symbol (that is, a data signal carried on an RE of non-pilot symbol 1×subcarrier 1 represented by a small gray grid in the intra-frequency asynchronous neighboring cell and the inter-frequency asynchronous neighboring cell in FIG. 6A to FIG. 6C), and a data signal from an inter-frequency synchronous neighboring cell on a pilot symbol (that is, a data signal carried on an RE of pilot symbol 1×subcarrier 1 represented by a small white grid in the inter-frequency synchronous neighboring cell in FIG. 6A to FIG. 6C).

Accordingly, a sum of the noise on the pilot signal of the serving cell and the pilot power from the intra-frequency synchronous neighboring cell is subtracted from the interference from the neighboring cell measured by the UE 101a, to obtain used data power of the neighboring cell, which includes a sum of data power on pilot symbols and a sum of data power on non-pilot symbols. The UE 101a and/or the UE 101b may measure pilot signal power and a signal to interference plus noise ratio on the pilot signal, that is, the RSRP and the SINR. Therefore, in this embodiment, the load rate of the neighboring cells is calculated based on the RSRP and the SINR. That is, the load rate of the neighboring cells may be calculated by using the following formula:

$$\begin{matrix}\frac{\begin{matrix}\frac{RSRP of a serving cell}{SINR of the serving cell} - Noise power on a pilot RE \\ of the serving cell - Sum of RSRP of intra - \\ frequency synchronous neighboring cells in the neighboring cells\end{matrix}}{Sum of data signal power of the neighboring cells on a} \\ unit RE in the case of full load\end{matrix} \qquad ( 1 )$$

In Formula (1), according to the definition of the RSRP, the RSRP is a linear average value of power contributions of REs that carry cell-specific reference signals in measured bandwidth. Therefore, the RSRP is signal energy measured by using an RE as a basic unit. Correspondingly, if an RE is used as a basic unit, a formula for calculating actual data power of all neighboring cells is as follows:

$$( \frac{RSRP ( i = 0 )}{SINR ( i = 0 )} ) - {N}_{0} - {\sum }_{i ∈ Intra - frequency cells} ( P ( B ) \times RSRP ( i ) ) \qquad ( 2 )$$

In Formula (2), i=0 indicates that the RSRP and the SINR in the formula are RSRP and an SINR of a serving cell, and N₀ is noise on a pilot RE of the serving cell, where the pilot RE is an RE that carries the pilot signal, for example, a small black grid in FIG. 6A to FIG. 6C. According to some embodiments of this application, the noise may be obtained by averaging all REs on one OFDM pilot symbol in total cell bandwidth. Generally, the value of N₀ depends on hardware performance of the UE 101a and/or the UE 101b. In other words, the value of N₀ is determined by a transceiver chip used by the client. RSRP(i) indicates the RSRP of the i^{th} (i≥1) neighboring cell, and P(B) is the probability of synchronization between the neighboring cell and the serving cell. Σ_{i∈Intra-frequency cells}(P(B)×RSRP(i)) is used to calculate a sum of RSRP of intra-frequency synchronous cells of the serving cell. Whether a neighboring cell and the serving cell are intra-frequency may be determined based on the quantity of antenna transmit ports of the base station 102 and a PCI (Physical Cell Identifier, physical cell identifier) of the neighboring cell. For example, a modulo operation may be performed on the quantity of antenna transmit ports of the base station 102 based on a value of the PCI of the neighboring cell, to determine whether the neighboring cell and the serving cell are intra-frequency. The foregoing modulo operation is usually implemented by using a mod function (that is, PCI mod MO). The PCI is replaced by the value of the PCI. A value of the MO varies according to the quantity of ports of the base station 102. If the quantity of antenna transmit ports of the base station 102 is a single port, the modulo of the quantity of antenna transmit ports is 6, that is, MO=6. If the quantity of antenna transmit ports of the base station 102 is 2 or 4, the modulo of the quantity of antenna transmit ports is 3,that is, MO=3. Whether the neighboring cell and the serving cell are intra-frequency can be determined by comparing the PCI mod MO value of the neighboring cell with the PCI mod MO value of the serving cell. Specifically, if the value of the PCI mod MO of the neighboring cell is equal to the value of the PCI mod MO of the serving cell, the neighboring cell and the serving cell are intra-frequency. If the value of the PCI mod MO of the neighboring cell is not equal to the value of the PCI mod MO of the serving cell, the neighboring cell and the serving cell are inter-frequency.

In Formula (2),

$$( \frac{RSRP ( i = 0 )}{SINR ( i = 0 )} )$$

is a ratio of the RSRP to the SINR of the serving cell, and represents noise and interference measured on a pilot signal in the serving cell. According to the foregoing definition of interference, the interference refers to interference caused by a signal of a neighboring cell to the serving cell, and the interference may include a sum of signal power of neighboring cells measured by the UE 101a and/or the UE 101b. Therefore, the interference caused by the neighboring cells to the serving cell is obtained by subtracting the noise N₀ on the pilot signal from

$$( \frac{RSRP ( i = 0 )}{SINR ( i = 0 )} ) ,$$

that is, the sum of signal power from the neighboring cells measured by the UE 101a and/or the UE 101b. The cell load rate may be considered as a ratio of actually used cell resources to available cell resources, or an actual utilization rate of cell resources. Therefore, the neighboring cell load rate may be obtained based on a ratio of a sum of used data power of the neighboring cells measured by the UE 101a and/or the UE 101b to a sum of data power of the neighboring cells measured by the UE 101a and/or the UE 101b in the case of full load. The full load described herein may include that resource elements (RE) for carrying data in a resource block (RB) of a neighboring cell are 100% used, including small white grids on pilot symbols and small gray grids on non-pilot symbols of the neighboring cell as shown in FIG. 6A to FIG. 6C.

The sum of used data power from the neighboring cells can be obtained by subtracting the noise N₀ on pilot REs and a sum of RSRP of the intra-frequency synchronous cells from

$$( \frac{RSRP ( i = 0 )}{SINR ( i = 0 )} ) .$$

In other words, a pilot signal of the serving cell is interfered with by a pilot signal of a neighboring cell when the neighboring cell and the serving cell are intra-frequency and synchronous, that is, the interference caused by the neighboring cells to the serving cell includes Σ_{i∈Intra-frequency cells}(P(B)×RSRP(i)), which is a sum of power of pilot signals, and therefore needs to be subtracted. The difference (namely, the numerator of formula 1) is the sum of used data signal power of all neighboring cells, this is, the expression of the numerator of the neighboring cell load rate.

According to some embodiments of this application, the UE 101a and/or the UE 101b may obtain, by using a pilot signal, a sum of data power of all neighboring cells in the case of full load. The sum of data power is measured by using an RE as a unit and can be calculated from the RSRP(i) of the neighboring cell. According to some embodiments of this application, the UE 101a and/or the UE 101b in the serving cell 201 may obtain the RSRP(i) of the neighboring cell by performing cell measurement. According to the schematic diagram shown in FIG. 6A to FIG. 6C and the analysis in S52, a sum of energy (power) of data signals of all neighboring cells on a unit RE in the case of full load that can be measured by the UE 101a and/or the UE 101b is:

$${\sum }_{i ∈ Intra - frequency neighboring cells} ( P ( A ) \times n \times {ρ}_{A} \times RSRP ( i ) ) + {\sum }_{i ∈ Inter - frequency neighboring cells} ( P ( A ) \times {ρ}_{A} + ( P ( B ) \times {ρ}_{B} ) \times n \times RSRP ( i ) \qquad ( 3 )$$

In Formula (3), RSRP(i) represents RSRP of a neighboring cell whose number is i, P(A) is a probability of asynchronization between each of the neighboring cells 202a to f and the serving cell 201, P(B) is a probability of synchronization between each of the neighboring cells 202a to f and the serving cell 201. Values of P(A) and P(B) vary slightly according to different composition of RBs. In the embodiment shown in FIG. 6A to FIG. 6C, P(A)=2/7, and P(B)=5/7. ρ_{A} is a ratio of data signal power to pilot signal power on a non-pilot symbol, ρ_{B} is a ratio of data signal power to pilot signal power on a pilot symbol, where proportional relationship between ρ_{A} and ρ_{B} may also differ depending on different cell configurations (as shown in Table 1), and n is a quantity of antenna transmit ports of the base station 102 (usually 1, 2, and 4). Σ_{i∈Intra-frequency neighboring cells}(P(A)×n×ρ_{A}×RSRP(i)) represents a sum of data power on non-pilot symbols of all intra-frequency asynchronous neighboring cells of the serving cell 201 in the case of full load. As shown in FIG. 6A to FIG. 6C, the sum of data power may be a sum of data power in a small gray grid of all intra-frequency asynchronous neighboring cells of the serving cell 201. Σ_{i∈Inter-frequency neighboring cells}(P(A)×ρ_{A}+P(B)×ρ_{B}×n×RSRP(i) represents a sum of data power (energy) of all inter-frequency neighboring cells of the serving cell 201 in the case of full load. As shown in FIG. 6A to FIG. 6C, the sum of data power may be a sum of data power in a small white grid of all inter-frequency synchronous neighboring cells of the serving cell 201 plus a sum of data power in a small gray grid of all inter-frequency asynchronous neighboring cells of the serving cell 201.

In conclusion, the formula for the load rate of the neighboring cells in this embodiment is as follows:

$${L}_{N} = \frac{\begin{matrix}( \frac{RSRP ( i = 0 )}{SINR ( i = 0 )} ) - {N}_{0} - \\ {\sum }_{i ∈ Intra - frequency neighboring cells} ( P ( B ) \times RSRP ( i ) )\end{matrix}}{\begin{matrix}{\sum }_{i ∈ Intra - frequency neighboring cells} ( P ( A ) \times n \times {ρ}_{A} \times \\ RSRP ( i ) ) + {\sum }_{i ∈ Inter - frequency neighboring cells} \\ ( P ( A ) \times {ρ}_{A} + ( P ( B ) \times {ρ}_{B} ) \times n \times RSRP ( i )\end{matrix}} \qquad ( 4 )$$

In Formula (4), i represents a cell number, i=0 represents the serving cell,

$$( \frac{RSRP ( i = 0 )}{SINR ( i = 0 )} )$$

represents a ratio of the RSRP of the serving cell to the SINR of the serving cell, N₀ is noise on a pilot RE of the serving cell, RSRP(i) represents RSRP of a neighboring cell whose number is i, P(A) is the probability of asynchronization between each of the neighboring cells and the serving cell, P(B) is the probability of synchronization between each of the neighboring cells and the serving cell, ρ_{A} is a ratio of data signal power to pilot signal power on a non-pilot symbol, ρ_{B} is a ratio of data signal power to pilot signal power on a pilot symbol, and n is a quantity of antenna ports of the base station.

It can be seen that even when whether a neighboring cell is a synchronous neighboring cell or an asynchronous neighboring cell is unknown, by introducing the probability of synchronization between each of the neighboring cells and the serving cell, the probability of asynchronization (asynchronization) between each of the neighboring cells and the serving cell, and the ratio of the data signal power to the pilot signal power, the sum of used data signal power included in the interference caused by the neighboring cells to the serving cell and the sum of data power of the neighboring cells that can be measured by the user equipment in the case of full load can be accurately calculated in a simple manner. Then, the load rate of the neighboring cells is calculated. In addition, different data signal power caused by different quantities of antenna transmit ports of the base station is considered, so that the calculated load rate is more accurate and reliable.

A person skilled in the art may know that, in the foregoing formula, neighboring cells are classified from the perspective of intra-frequency and inter-frequency, and then the data signal power is calculated based on the configuration parameters n, ρ_{A} and ρ_{B}. However, a person skilled in the art should understand that the load rate of the neighboring cells may also be obtained through other calculation methods, for example, the load rate of the neighboring cells may be calculated when the neighboring cells are classified from the perspective of synchronization and asynchronization. For another example, it may be inferred that all neighboring cells are asynchronous neighboring cells.

Then, S54 is performed to calculate the load rate of the serving cell 201. Considering that the user equipment 101a can obtain the RSSI through cell measurement, that is, the sum of received signal power in total bandwidth (that is, total cell bandwidth) on a pilot symbol, in this embodiment, power such as noise in the total bandwidth on the pilot symbol and power such as interference caused by the neighboring cells to the serving cell may be subtracted from the RSSI, to obtain a sum of used data signal power in the serving cell. As described above, the total bandwidth of the serving cell may be a difference between a maximum frequency and a minimum frequency generated after a plurality of RBs are superimposed in frequency domain. When the RSSI is total received signal power on one pilot symbol and in the total bandwidth, the total received signal power usually includes noise and interference, and a sum of pilot signal power on the pilot symbol and in the total bandwidth. Therefore, if these components are subtracted from the RSSI, the difference is the sum of actually used data power in the total bandwidth in the serving cell. Further, the load rate of the serving cell can be obtained according to a ratio of the sum of used data power in the total bandwidth to the sum of data power in the total bandwidth on the pilot symbol of the serving cell in the case of full load (that is, the sum of data power of all small white grids in the total bandwidth on the pilot symbol of the serving cell). That is, a formula for calculating the load rate of the serving cell is as follows:

$$\frac{\begin{matrix}RSSI - Sum of the RSRP of the serving cell on an OFDM \\ symbol and in total bandwidth - Noise in the total bandwidth - \\ Interference caused by the neighboring cells to the serving cell\end{matrix}}{\begin{matrix}Sum of data signal power of the serving cell on the OFDM \\ symbol and in the total bandwidth in the case of full load\end{matrix}} \qquad ( 5 )$$

The interference caused by the neighboring cells 201a to f to the serving cell 201 may include a sum of data signal power measured by the UE 101a and/or the UE 101b on an OFDM symbol and in total bandwidth in other neighboring cells other than intra-frequency synchronous neighboring cells in the neighboring cells 201a to f, and a sum of pilot signal power on an OFDM symbol (that is, on a pilot symbol) and in total bandwidth in the intra-frequency synchronous neighboring cell (a sum of pilot power carried on small black grids in FIG. 6A to FIG. 6C). When the RSSI represents the total received signal power on one pilot symbol and in the total bandwidth, the sum of data signal power in the total bandwidth on an OFDM symbol in other neighboring cells other than intra-frequency synchronous neighboring cells may include: a sum of data signal power in the total bandwidth on a pilot symbol in an inter-frequency synchronous neighboring cell (a sum of power carried on small white grids in FIG. 6A to FIG. 6C), and a sum of data signal power in the total bandwidth on one non-pilot symbol in asynchronous neighboring cells (including an intra-frequency asynchronous neighboring cell and an inter-frequency asynchronous neighboring cell) (a sum of power carried on small gray grids in FIG. 6A to FIG. 6C). According to the definition of the load rate, the following can be obtained:

Sum of used data power =Sum of data power in the case of full load×Cell load rate

The sum of used data power is the data signal power part in the interference from the neighboring cell measured by the UE 101a and/or the UE 101b (that is, a data signal to the neighboring cell and interference to the user equipment). According to formula 4, load rates of all neighboring cells are obtained. Therefore, interference caused by the neighboring cells to the serving cell 201 may be simply calculated by using the following formula:

(sum of the data signal power of the neighboring cells measured by the user equipment on an OFDM symbol and in total bandwidth in the case of full load)>load rate of the neighboring cells+(sum of the RSRP of the intra-frequency synchronous neighboring cells on the OFDM symbol and in the total bandwidth) (6)

In some embodiments, the load rate L_{N} of the neighboring cells, the quantity n of antenna transmit ports of the base station, the probability of synchronization P(B) between the serving cell and each of the neighboring cells, the probability of asynchronization P(A) between the serving cell and each of the neighboring cells, and the ratios ρ_{A} and ρ_{B} of the data signal power to the pilot signal power are substituted into formula 6, and a formula for calculating the interference caused by the neighboring cells to the serving cell may be obtained:

$${\sum }_{i = 1}^{I} ( P ( A ) \times {ρ}_{A} \times RSRP ( i ) \times {NRS}_{RE - A} ( n ) \times N \times {L}_{N} + P ( B ) \times ( {RS}_{RE - B} ( n ) + {ρ}_{B} \times {NRS}_{RE - B} ( n ) \times {L}_{N} ) \times RSRP ( i ) \times N ) \qquad ( 7 )$$

In Formula (7), I represents a maximum quantity of neighboring cells, i represents a number of the neighboring cell, RSRP(i) represents RSRP of a neighboring cell whose number is i, P(A) is the probability of asynchronization between each of the neighboring cells and the serving cell, P(B) is the probability of synchronization between each of the neighboring cells and the serving cell, ρ_{A} is a ratio of data signal power to pilot signal power on a non-pilot symbol, ρ_{B} is a ratio of data signal power to pilot signal power on a pilot symbol, N is a quantity of resource blocks (Resource Block, RB) corresponding to total cell bandwidth, n is the quantity of antenna ports of the base station, NRS_{RE-A}(n) is a quantity of resource elements (Resource Element, RE) that are on a non-pilot symbol in one RB and used to send a data signal (a quantity of small gray grids on a non-pilot symbol as shown in FIG. 6A to FIG. 6C), RS_{RE-B}(n) is a quantity of REs that are on a pilot symbol in one RB and used to send a pilot signal (a quantity of small black grids on a pilot symbol as shown in FIG. 6A to FIG. 6C), and NRS_{RE-B}(n) is a quantity of REs that are on a pilot symbol in one RB and used to send a data signal (a quantity of small white grids on a pilot symbol as shown in FIG. 6A to FIG. 6C).

Formula (7) is split for analysis. It can be learned that Σ_{i∈Inter-frequency neighboring cells}P(A)×ρ_{A}×RSRP(i)×NRS_{RE-A}(n)×N calculates a sum of data energy of all asynchronous neighboring cells on an OFDM symbol and in total bandwidth in the case of full load, that is, as shown in FIG. 6A to FIG. 6C, a sum of data power of all asynchronous neighboring cells carried on small gray grids on a non-pilot symbol and in total bandwidth in the case of full load Σ_{i∈Inter-frequency neighboring cells}P(A)×ρ_{A}×RSRP(i)×NRS_{RE-A}(n)×N×L_{N} calculates a sum of used data power of all asynchronous neighboring cells on an OFDM symbol and in total bandwidth.

Σ_{i∈Synchronous neighboring cells}P(B)×ρ_{B}×NRS_{RE-B}(n)×RSRP(i)×N calculates a sum of data power of all synchronous neighboring cells on an OFDM symbol and in total bandwidth in the case of full load, that is, as shown in FIG. 6A to FIG. 6C, a sum of data power of all synchronous neighboring cells carried on small white grids on a pilot symbol and in total bandwidth. Σ_{i∈Synchronous neighboring cells}P(B)×ρ_{B}×NRS_{RE-B}(n)×RSRP(i)×N×L_{N} calculates a sum of used data power of all synchronous neighboring cells on an OFDM symbol and in total bandwidth.

Σ_{i∈Intra-frequency synchronous neighboring cells}P(B)×RS_{RE-B}(n)×RSRP(i)×N calculates a sum of pilot signal power of all intra-frequency synchronous neighboring cells on an OFDM symbol and in total bandwidth, that is, as shown in FIG. 6A to FIG. 6C, a sum of pilot signal power of all intra-frequency synchronous cells carried on small black grids on a pilot symbol and in total bandwidth.

Specific values of RS_{RE-B}(n), NRS_{RE-B}(n), and NRS_{RE-A}(n), and RS_{RE-A}(n) to be used in the following may be determined according to the following Table 2.

TABLE 2
Allocation of quantity of REs in each physical
RB under different configurations

| Quantity of | Pilot symbol | | Non-pilot symbol | |
|---|---|---|---|---|
| antenna ports (n) | RS_{RE-B}(n) | NRS_{RE-B}(n) | RS_{RE-A}(n) | NRS_{RE-A}(n) |
| 1 | 2 | 10 | 0 | 12 |
| 2 | 4 | 16 | 0 | 24 |
| 4 | 4 | 32 | 4/0 | 32/48 |

In the table above, RS_{RE-B}(n) indicates a quantity of pilot signals allocated to pilot symbols in a physical RB when there are n antenna ports. NR_{SRE-B}(n) indicates a quantity of data signals allocated to pilot symbols in a physical RB when there are n antenna ports. RS_{RE-A}(n) indicates a quantity of pilot signals allocated to non-pilot symbols in a physical RB when there are n antenna ports. NRS_{RE-A}(n) indicates a quantity of data signals allocated to non-pilot symbols in a physical RB when there are n antenna ports.

Finally, in this embodiment, according to formula 7, a specific formula for calculating the load rate of the serving cell may be obtained as follows:

$${L}_{0} = \frac{\begin{matrix}RSSI - N \times {RS}_{RE - B} ( n ) \times RSRP ( i ) - Noise - \\ {\sum }_{i = 1}^{J} ( P ( A ) \times {ρ}_{A} \times RSRP ( i ) \times {NRS}_{RE - A} ( n ) \times N \times {L}_{N} + \\ P ( B ) \times ( {RS}_{RE - B} ( n ) + {ρ}_{B} \times {NRS}_{RE - B} ( n ) \times {L}_{N} ) \times RSRP ( i ) \times N )\end{matrix}}{{ρ}_{B} \times RSRP ( i = 0 ) \times {NRS}_{RE - B} ( n ) \times N} \qquad ( 8 )$$

In Formula (8), N is the quantity of resource blocks (Resource Block, RB) corresponding to the total cell bandwidth, n is the quantity of antenna ports of the base station, NRS_{RE-A}(n) is the quantity of resource elements (Resource Element, RE) that are on the non-pilot symbol and used to send data, RS_{RE-B}(n) is the quantity of REs that are on the pilot symbol and used to send a pilot. NRS_{RE-B}(n) is the quantity of REs that are on the pilot symbol and used to send data, Noise is power of noise in the total cell bandwidth, I represents the maximum quantity of neighboring cells, i represents the number of the neighboring cell, RSRP(i) represents the RSRP of the neighboring cell, P(A) is the probability of asynchronization between each of the neighboring cells and the serving cell, P(B) is the probability of synchronization between each of the neighboring cells and the serving cell, ρ_{A} is the ratio of data signal power to pilot signal power on the non-pilot symbol, and ρ_{B} is the ratio of data signal power to pilot signal power on the pilot symbol. Calculation of Noise is related to bandwidth, ambient temperature, and inherent performance of a radio frequency component used by the user equipment that are concerned during

Noise calculation. In most cases, a value of Noise can be −125 dBm.

In Formula (8), Σᵢ₌₁^{j}P(B)×RS_{RE-B}(n)×RSRP(i)×N calculates a sum of RSRP of the serving cell on the OFDM symbols and in the total bandwidth in formula 5, and specifically, calculates a sum of pilot signal power of the serving cell 201 on a pilot symbol and in total bandwidth, that is, a sum of pilot signal power in small black grids shown in FIG. 6A to FIG. 6C.

In Formula (8), Σᵢ₌₁ⁱ(P(A)×ρ_{A}×RSRP(i)×NRS_{RE-A}(n)×N×L_{N}+P(B)×(RS_{RE-B}(n)+ρ_{B}×NRS_{RE-B}(n)×L_{N})×RSRP(i)×N) calculates a sum of interference caused by the neighboring cells to the serving cell in Formula (7).

ρ_{B}×RSRP(i=0)×NRS_{RE-B}(n)×N calculates a sum of data signal power of the serving cell 201 on an OFDM symbol in total bandwidth in the case of full load, that is, as shown in FIG. 6A to FIG. 6C, a sum of data signal power of the serving cell on a pilot symbol and in all small white grids in total bandwidth. The full load herein may include that resource elements (RE) for carrying data in a resource block (RB) of the serving cell are 100% used, including small white grids on pilot symbols of the serving cell as shown in FIG. 6A to FIG. 6C.

More accurate load rate data is obtained through S54, and S55 may be further performed at least partially based on the load rate, to determine whether the serving cell is congested. For example, a cell congestion threshold may be set, When the load rate exceeds the threshold, it is determined that the cell is congested.

In the embodiment shown in FIG. 5 of determining whether the serving cell is congested by calculating the load rate of the serving cell, a sum of signal energy of different types of neighboring cells in the case of full load are calculated based on a probability of synchronization and a probability of asynchronization between the serving cell and each of the neighboring cells (that is, P(B) and P(A)). In addition, the interference caused by the neighboring cells to the serving cell is further obtained by multiplying the sum of the foregoing signal energy by the load rate L_{N} of all neighboring cells. In addition, in the calculation process, the pilot signal power is further converted into the data signal power based on the ratios (ρ_{A} and ρ_{B}) of the data signal power to the pilot signal power that are configured in the system. In this way, data signal power that is more accurate than that in a conventional technology is obtained and an error caused by non-data signal power is eliminated. In addition, different data signal power caused by different quantities of antenna transmit ports of the base station is considered, so that the calculated load rate can be more accurate and reliable.

Although formula (8) shows that the interference caused by the neighboring cells to the serving cell is calculated based on synchronous or asynchronous neighboring cells, a person of ordinary skill in the art may know that calculating the interference caused by the neighboring cells to the serving cell based on intra-frequency or inter-frequency neighboring cells is also one of feasible solutions. Alternatively, when signal strength of the neighboring cell is very small, the interference caused by the neighboring cells may be ignored.

In conclusion, in the foregoing embodiment, from a perspective of probability statistics, based on signal power (for example, RSRP and RSSI) obtained through measurement, a probability of synchronization or asynchronization is used as a weight value, and based on a ratio of a data signal to a pilot signal, data signal power is separated from the signal power (RSRP and RSSI). A ratio of pure data power is used as the load rate of the serving cell. The load rate is closer to the actual cell load rate. A congestion status determined based on the load rate is more reliable and trustworthy.

Embodiments of the present invention may be implemented in hardware, firmware, software, or any combination thereof. Embodiments of the present invention may also be implemented as instructions stored on a machine-readable medium, and the instructions may be read and executed by one or more processors. The machine-readable medium may include any mechanism for storing or transmitting information in a form that is readable by a machine (for example, a computing device). For example, the machine-readable medium may include a read-only memory (ROM), a random access memory (RAM), a disk storage medium, an optical storage medium a flash memory device, a propagated signal in an electrical, optical, acoustic or another form (for example, a subcarrier, an infrared signal, a digital signal, or the like), and others.

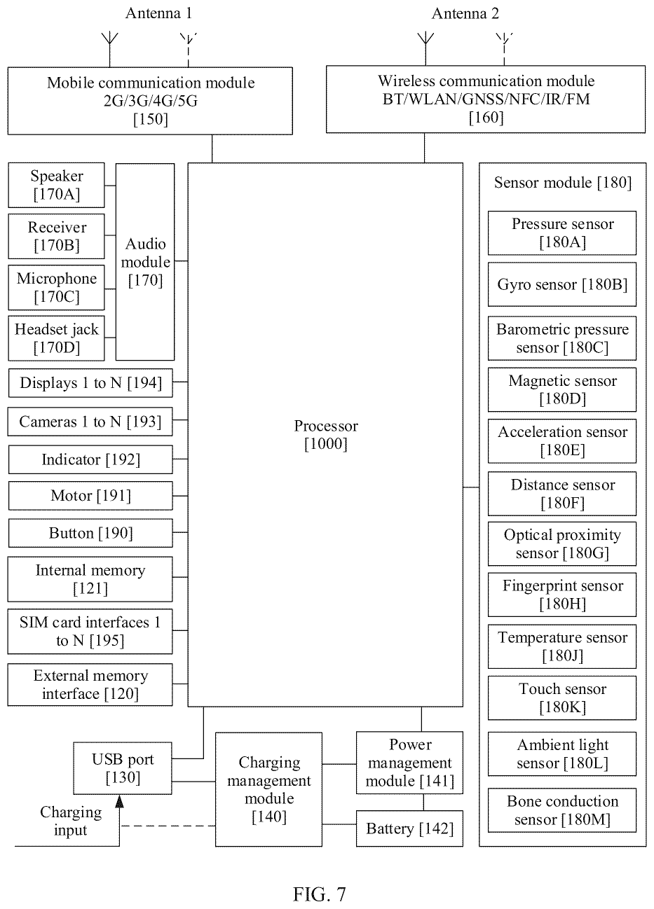

FIG. 7 is a schematic diagram of a system of UE 101a and/or UE 101b according to some embodiments of this application.

The UE 101a and/or UE 101b may include a processor 1000, an external memory interface 120, an internal memory 121, a universal serial bus (universal serial bus, USB) port 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and the like. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this application does not constitute a specific limitation on the UE 101a and/or the UE 101b. In some other embodiments of this application, the UE 101a and/or the UE 101b may include more or fewer components than those shown in the figure, or combine some components, or split some components, or have different component arrangements. The components shown in the figure may be implemented as hardware, software, or a combination of software and hardware.

The processor 1000 may include one or more processing units. For example, the processor 1000 may include a central processing unit (Central Processing Unit, CPU), a microprocessor (Micro-programmed Control Unit, MCU), an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural network processing unit (neural-network processing unit, NPU), or the like.

The modem is configured to modulate, according to a 3GPP protocol, a baseband signal that is to be transmitted into a modulated signal that can be transmitted by using an antenna, and demodulate a signal received by the antenna into a baseband signal that can be processed by the processor of the UE 101a and/or the UE 101b Different processing units may be independent components, or may be integrated into one or more processors.

The processor may generate an operation control signal based on an instruction operation code and a time sequence signal, to complete control of instruction reading and instruction execution.

A memory may be further disposed in the processor 1000, and is configured to store instructions and data. In some embodiments, the memory in the processor 1000 is a cache memory. The memory may store instructions or data that has been recently used or cyclically used by the processor 1000. If the processor 1000 needs to use the instructions or the data again, the processor may directly invoke the instructions or the data from the memory. This avoids repeated access, reduces waiting time of the processor 1000, and improves system efficiency

In some embodiments, the processor 1000 may include one or more interfaces. The interface may include an integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, and a subscriber identification module (subscriber identity module, SIM) interface.

A wireless communication function of the UE 101a and/or the UE 101b, for example, a cell search method according to embodiments of this application, may be implemented by using the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the UE 101a and/or the UE 101b may be configured to cover a single or a plurality of communication frequency bands. Different antennas may be further multiplexed, to improve antenna utilization. For example, the antenna 1 may be multiplexed as a diversity antenna in a wireless local area network. In some other embodiments, the antenna may be used in combination with a tuning switch.

The mobile communication module 150 may provide a solution for wireless communication such as 2G/3G/4G/5G applied to the UE 101a and/or the UE 101b. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules of the mobile communication module 150 may be disposed in the processor 1000. In some embodiments, at least some functional modules of the mobile communication module 150 may be disposed in a same device as at least some modules of the processor 1000. As shown in FIG. 5, the NAS layer, the RRC layer, and the PHY layer according to embodiments of this application may be disposed in the mobile communication module 150 as functional modules.

The modem processor may include a modulator and a demodulator. The modulator is configured to modulate a to-be-sent low-frequency baseband signal into a medium-high frequency signal. The demodulator is configured to demodulate a received electromagnetic wave signal into a low frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A, the receiver 170B, or the like), or displays an image or a video through the display 194. In some embodiments, the modem processor may be an independent component. In some other embodiments, the modem processor may be independent of the processor 1000, and is disposed in a same device as the mobile communication module 150 or another functional module.

In some embodiments, the antenna 1 and the mobile communication module 150 in the UE 101a and/or the UE 101b are coupled, and the antenna 2 and the wireless communication module 160 are coupled, so that the UE 101a and/or the UE 101b can communicate with a network and another device by using a wireless communication technology. The wireless communication technology may include technologies such as global system for mobile communications (global system for mobile communications, GSM), general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, GNSS. WLAN, NFC, FM, IR, and/or the like.

The external memory interface 120 may be configured to connect to an external memory card, for example, a micro SD card, to extend a storage capability of the UE 101a and/or the UE 101b. The external memory card communicates with the processor 1000 by using the external memory interface 120, to implement a data storage function. For example, files such as music and videos are stored in the external storage card. In this embodiment of this application, a cell search parameter table may be stored in an external memory card connected by using the external memory interface 120.

The internal memory 121 may be configured to store computer-executable program code. The executable program code includes instructions. The internal memory 121 may include a program storage area and a data storage area. The program storage area may store an operating system, an application required for at least one function (such as a sound play function and an image play function), and the like. The data storage area may store data (such as audio data and a phone book) created during use of the UE 101a and/or the UE 101b, and the like. In addition, the internal memory 121 may include a high-speed random access memory, and may further include a non-volatile memory, for example, at least one magnetic disk storage device, a flash storage device, and a universal flash storage (universal flash storage, UFS) The processor 1000 runs instructions stored in the internal memory 121 and/or instructions stored in the memory disposed in the processor, to perform various function applications and data processing of the UE 101a and/or the UE 101b. In this embodiment of this application, the internal memory 121 may be configured to store the cell search parameter table, and the processor 1000 may be configured to perform the cell search method shown in FIG. 3 and FIG. 4A and FIG. 4B.

The SIM card interface 195 is configured to connect to a SIM card. The SIM card may be inserted into the SIM card interface 195 or removed from the SIM card interface 195, to implement contact with or separation from the UE 101a and/or the UE 101b. The UE 101a and/or the UE 101b may support one or N SIM card interfaces, where N is a positive integer greater than 1. The SIM card interface 195 may support a nano-SIM card, a micro-SIM card, a SIM card, and the like. A plurality of cards may be inserted into a same SIM card interface 195. Types of the plurality of cards may be the same or different. The SIM card interface 195 may also be compatible with different types of SIM cards. The SIM card interface 195 may also be compatible with an external storage card. The UE 101a and/or the UE 101b interacts with a network through the SIM card, to implement functions such as calling and data communication. In some embodiments, the UE 101a and/or the UE 101b uses an eSIM, namely, an embedded SIM card. The eSIM card may be embedded in the UE 101a and/or the UE 101b, and cannot be separated from the UE 101a and/or the UE 101b. In this embodiment of this application, information of a wireless communication network such as a PLMN may be stored in an SIM card.

All method implementations of this application may be implemented by software, a magnetic component, firmware, or the like.

Program code may be used to input instructions, to perform the functions described in this specification and generate output information. The output information may be applied to one or more output devices in a known manner. For a purpose of this application, a processing system includes any system having a processor such as a digital signal processor (DSP), a microcontroller, an application-specific integrated circuit (ASIC), or a microprocessor.

The program code may be implemented in a high-level programming language or an object-oriented programming language to communicate with the processing system. The program code can also be implemented in an assembly language or a machine language when needed. Actually, the mechanism described in this specification is not limited to the scope of any particular programming language. In either case, the language may be a compiled language or an interpreted language.

One or more aspects of at least one embodiment may be implemented by using representative instructions stored in a computer-readable storage medium. The instructions represent various types of logic in a processor, and when the instructions are read by a machine, the machine is enabled to manufacture logic for performing the technologies described in this specification. These representations referred to as “IP cores” may be stored in a tangible computer-readable storage medium, and provided for a plurality of customers or production facilities for loading into a manufacturing machine that actually manufactures the logic or the processor.

Although description of this application is provided with reference to preferred embodiments, this does not mean that features of this application are limited to this implementation. On the contrary, a purpose of describing the present invention with reference to the implementations is to cover other selections or modifications that may be derived based on the claims of this application. To provide in-depth understanding of this application, the following descriptions include a plurality of specific details. This application may be alternatively implemented without using these details. In addition, to avoid confusion or blurring a focus of this application, some specific details are omitted from the description. It should be noted that embodiments in this application and the features in embodiments may be mutually combined in the case of no conflict.

Furthermore, various operations are described as a plurality of discrete operations in a manner that is most conducive to understanding illustrative embodiments. However, an order of description should not be construed as implying that these operations need to depend on the order. In particular, these operations do not need to be performed in the provided order.

As used herein, a term “module” or “unit” may mean, be, or include: an application-specific integrated circuit (ASIC), an electronic circuit, a (shared, dedicated, or group) processor and/or a memory that executes one or more software or firmware programs, a composite logic circuit, and/or another proper component that provides the described functions.

In the accompanying drawings, some structure or method features may be shown in a particular arrangement and/or order. However, it should be understood that such a particular arrangement and/or order may not be required. In some embodiments, these features may be arranged in a manner and/or order different from that shown in the illustrative accompanying drawings. In addition, inclusion of the structure or method features in a particular figure does not imply that such features are required in all embodiments, and in some embodiments, these features may not be included or may be combined with other features.

Embodiments of a mechanism disclosed in this application may be implemented in hardware, software, firmware, or a combination of these implementation methods. Embodiments of this application may be implemented as a computer program or program code executed in a programmable system. The programmable system includes a plurality of processors, a storage system (including volatile and non-volatile memories and/or storage elements), a plurality of input devices, and a plurality of output devices.

The program code may be used to input instructions, to perform the functions described in this application and generate output information. The output information may be applied to one or more output devices in a known manner. For a purpose of this application, a processing system includes any system having a processor such as a digital signal processor (DSP), a microcontroller, an application-specific integrated circuit (ASIC), or a microprocessor.

The program code may be implemented in a high-level programming language or an object-oriented programming language to communicate with the processing system. The program code can also be implemented in an assembly language or a machine language when needed. Actually, the mechanism described in this application is not limited to the scope of any particular programming language. In either case, the language may be a compiled language or an interpreted language.

In some cases, the disclosed embodiments may be implemented in hardware, firmware, software, or any combination thereof. In some cases, one or more aspects of at least some embodiments may be implemented by representative instructions stored in a computer-readable storage medium. The instructions represent various types of logic in a processor, and when the instructions are read by a machine, the machine is enabled to manufacture logic for performing the technologies described in this application. These representations referred to as “IP cores” may be stored in a tangible computer-readable storage medium, and provided for a plurality of customers or production facilities for loading into a manufacturing machine that actually manufactures the logic or the processor.

Such a computer-readable storage medium may include but is not limited to non-transient tangible arrangements of articles manufactured or formed by machines or devices. The computer-readable storage medium includes a storage medium, for example, a hard disk or any other type of disk including a floppy disk, a compact disc, a compact disc read-only memory (CD-ROM), a compact disc rewritable (CD-RW), or a magneto-optical disc; a semiconductor device, for example, a read-only memory (ROM), a random access memory (RAM) such as a dynamic random access memory (DRAM) or a static random access memory (SRAM), an erasable programmable read-only memory (EPROM), a flash memory, or an electrically erasable programmable read-only memory (EEPROM); a phase change memory (PCM); a magnetic card or an optical card; or any other type of proper medium for storing electronic instructions.

Therefore, embodiments of this application further include a non-transient computer-readable storage medium. The medium includes instructions or design data, for example, a hardware description language (HDL), and defines a structure, a circuit, an apparatus, a processor, and/or a system feature described in this application.

1-15. (canceled)

16. A method comprising:
measuring a received signal strength indicator (RSSI) and pilot signal received power of a serving cell in which a user equipment is located, wherein the pilot signal received power comprises a reference signal received power (RSRP);
calculating a load rate of the serving cell at least based on the RSSI, the RSRP, and at least one of a quantity of antenna transmit ports of a base station communicating with the user equipment, a first probability of synchronization between the serving cell and neighboring cells, a second probability of asynchronization between the serving cell and each of the neighboring cells, a ratio of a first power of a data signal from the base station to a second power of a pilot signal from the base station, or an interference caused by the neighboring cells to the serving cell, wherein the serving cell is adjacent to each of the neighboring cells; and
determining, at least based on the load rate and a cell congestion threshold, whether the serving cell is congested.

17. The method of claim 16, wherein calculating the load rate comprises:
calculating an average load rate of the neighboring cells; and
calculating, at least based on the average load rate, the interference.

18. The method of claim 17, wherein calculating the average load rate comprises:
measuring a signal-to-interference-plus-noise ratio (SINR) of the serving cell;
obtaining, based on the SINR, RSRPs of the neighboring cells; and
calculating the average load rate at least based on the RSRP and the SINR of the serving cell, the RSRPs of the neighboring cells, and at least one of the quantity of antenna transmit ports, the first probability, the second probability, or the ratio.

19. The method of claim 17, further comprising:
calculating the average load rate using the following formula:
$$\frac{\begin{matrix}\frac{RSRP of the serving cell}{SINR of the serving cell} - Noise power on a pilot RE of the serving cell - Sum \\ of RSRP of intra - frequency synchronous neighboring cells in the neighboring cells\end{matrix}}{\begin{matrix}Sum of data signal power of the neighboring cells on a unit RE \\ measured by the user equipment in the case of full load\end{matrix}} ,$$
wherein a first subcarrier frequency of the intra-frequency synchronous neighboring cell is the same as a second subcarrier frequency of the serving cell, wherein the intra-frequency synchronous neighboring cell is synchronous with the serving cell, and wherein a pilot resource element (RE) carries the pilot signal; and
calculating the sum of the RSRP of the intra-frequency synchronous neighboring cells and the sum of the data signal power on the RE based on at least one of the quantity of antenna transmit ports, the first probability, the second probability, or the ratio.

20. The method of claim 17, further comprising calculating the average load rate using the following formula:
$${L}_{N} = \frac{( \frac{RSRP ( i = 0 )}{SINR ( i = 0 )} ) - {N}_{0} - {\sum }_{i ∈ Intra - frequency neighboring cells} ( P ( B ) \times RSRP ( i ) )}{\begin{matrix}{\sum }_{i ∈ Intra - frequency neighboring cells} ( P ( A ) \times n \times {ρ}_{A} \times RSRP ( i ) ) + \\ {\sum }_{i ∈ Inter - frequency neighboring cells} ( P ( A ) \times {ρ}_{A} + P ( B ) \times {ρ}_{B} ) \times n \times RSRP ( i )\end{matrix}} ,$$
wherein i represents a cell number, i=0 represents the serving cell,
$$( \frac{RSRP ( i = 0 )}{SINR ( i = 0 )} )$$
represents a ratio of the RSRP of the serving cell to a signal-to-interference-plus-noise ratio (SINR) of the serving cell, N₀ is noise on a pilot resource element (RE) of the serving cell, RSRP(i) represents an RSRP of a neighboring cell whose number is i, P(A) is the second probability, P(B) is the first probability, ρ_{A} is a first ratio of data signal power to pilot signal power on a non-pilot symbol, ρ_{B} is a second ratio of data signal power to pilot signal power on a pilot symbol, and n is the quantity of antenna transmit ports.

21. The method of claim 17, further comprising further calculating the interference based on the average load rate and at least one of the quantity of antenna transmit ports, the first probability, the second probability, or the ratio.

22. The method of claim 17, further comprising:
calculating the interference using the following formula:
(sum of the data signal power of the neighboring cells by the user equipment on an orthogonal frequency-division multiplexing (OFDM) symbol and in total bandwidth in the case of full load)×average load rate of the neighboring cells+(sum of an RSRP of the intra-frequency synchronous neighboring cells on the OFDM symbol and in the total bandwidth),
wherein a carrier frequency of the intra-frequency synchronous neighboring cell is the same as a carrier frequency of the serving cell, and wherein the intra-frequency synchronous neighboring cell is synchronous with the serving cell; and
calculating the sum of the data signal power and the sum of the RSRP of the intra-frequency synchronous neighboring cells based on at least one of the quantity of antenna transmit ports, the first probability, the second probability, or the ratio.

23. The method of claim 17, further comprising further calculating the interference using the following formula:
$${\sum }_{i = 1}^{I} ( P ( A ) \times {ρ}_{A} \times RSRP ( i ) \times {NRS}_{RE - A} ( n ) \times N \times {L}_{N} + P ( B ) \times {RS}_{RE - B} ( n ) + {ρ}_{B} \times {NRS}_{RE - B} ( n ) \times {L}_{N} \times RSRP ( i ) \times N ) ,$$
wherein I represents a maximum quantity of neighboring cells, i represents a cell number, RSRP(i) represents an RSRP of a neighboring cell whose number is i, P(A) is the second probability, P(B) is the first probability, ρ_{A} is a ratio of data signal power to pilot signal power on a non-pilot symbol, ρ_{B} is a ratio of data signal power to pilot signal power on a pilot symbol, N is a quantity of resource blocks (RBs) corresponding to total cell bandwidth, n is the quantity of antenna ports, NRS_{RE-A}(n) is a first quantity of resource elements (REs) that are on a non-pilot symbol in a first RB and send a data signal, RS_{RE-B}(n) is a second quantity of REs that are on a pilot symbol in a second RB and send a pilot signal, and NRS_{RE-B}(n) is a quantity of REs that are on a pilot symbol in a third RB and send a data signal.

24. The method of claim 16, further comprising:
further calculating the load rate using the following formula:
$$\frac{\begin{matrix}RSSI - Sum of the RSRP of the serving cell on an OFDM symbol and in total bandwidth - Noise \\ in the total bandwidth - Interference caused by the neighboring cells to the serving cell\end{matrix}}{\begin{matrix}Sum of the data signal power of the serving cell measured by the user equipment \\ on the OFDM symbol and in the total bandwidth in the case of full load\end{matrix}} ;$$
and
calculating the sum of the RSRP of the serving cell on the OFDM symbol and in the total bandwidth, the interference, and the sum of the data signal power of the serving cell on the OFDM symbol and in the total bandwidth based on at least one of the quantity of antenna transmit ports, the first probability, the second probability, or the ratio.

25. The method of claim 16, further comprising further calculating the load rate using the following formula:
$${L}_{0} = \frac{\begin{matrix}RSSI - N \times {RS}_{RE - B} ( n ) \times RSRP ( i ) - Noise - \\ {\sum }_{i = 1}^{I} ( P ( A ) \times {ρ}_{A} \times RSRP ( i ) \times {NRS}_{RE - A} ( n ) \times N \times {L}_{N} + P ( B ) \times ( {RS}_{RE - B} ( n ) + {ρ}_{B} \times {NRS}_{RE - B} ( n ) \times {L}_{N} ) \times RSRP ( i ) \times N )\end{matrix}}{{ρ}_{B} \times RSRP ( i = 0 ) \times {NRS}_{RE - B} ( n ) \times N} ,$$
wherein N is the quantity of resource blocks (RBs) corresponding to the total cell bandwidth, n is the quantity of antenna ports, NRS_{RE-A}(n) is the quantity of resource elements (REs) that are on the non-pilot symbol and send data signal, RS_{RE-B}(n) is the quantity of REs that are on the pilot symbol and send a pilot signal, NRS_{RE-B}(n) is the quantity of REs that are on the pilot symbol and send data signal, Noise is power of background noise in the total cell bandwidth, I represents the maximum quantity of neighboring cells, i represents a cell number, RSRP(i) represents the RSRP of the neighboring cell, P(A) is the second probability, P(B) is the first probability, ρ_{A} is the ratio of data signal power to pilot signal power on the non-pilot symbol, and ρ_{B} is the ratio of data signal power to pilot signal power on the pilot symbol.

26. The method of claim 16, further comprising determining, when the serving cell is congested, whether to adjust a communication service between the user equipment and the base station.

27. The method of claim 26, further comprising:
comparing the RSRPs of the neighboring cells with the RSRP of the serving cell;
switching the serving cell to a neighboring cell with a largest RSRP in one or more neighboring cells in the neighboring cells when an RSRP of the one or more neighboring cells is greater than the RSRP of the serving cell;
calculating a second load rate of the neighboring cell with the largest RSRP;
determining, based on the second load rate, whether the neighboring cell with the largest RSRP is congested;
determining to camp on the neighboring cell with the largest RSRP when the neighboring cell with the largest RSRP is not congested; and
determining to switch a secondary card of the user equipment to a primary card when the neighboring cell with the largest RSRP is congested.

28. The method of claim 16, further comprising:
comparing a communication quality index between the user equipment and the base station with a quality threshold when the serving cell is not congested; and
reporting an exception to a server when the communication quality index reaches or exceeds the quality threshold.

29. An electronic device, comprising:
a memory configured to store instructions; and
one or more processors coupled to the memory and configured to:
measure a received signal strength indicator (RSSI) and pilot signal received power of a serving cell in which a user equipment is located, wherein the pilot signal received power comprises a reference signal received power (RSRP);
calculate a load rate of the serving cell at least based on the RSSI, the RSRP, and at least one of a quantity of antenna transmit ports of a base station communicating with the user equipment, a first probability of synchronization between the serving cell of the user equipment and neighboring cells, a second probability of asynchronization between the serving cell and each of the neighboring cells, a ratio of a first power of a data signal from the base station to a second power of a pilot signal from the base station, or an interference by the neighboring cells to the serving cell, wherein the serving cell is adjacent to each of the neighboring cells; and
determine, at least based on the load rate and a cell congestion threshold, whether the serving cell is congested.

30. The electronic device of claim 29, wherein the one or more processors are further configured to:
calculate an average load rate of the neighboring cells; and
calculate, at least based on the average load rate, the interference.

31. The electronic device of claim 30, wherein the one or more processors are further configured to:
measure a signal-to-interference-plus-noise ratio (SINR) of the serving cell;
obtain, based on the SINR, RSRPs of the neighboring cells; and
calculate the average load rate at least based on the RSRP and the SINR of the serving cell, the RSRPs of the neighboring cells, and at least one of the quantity of antenna transmit ports, the first probability, the second probability, and the ratio.

32. The electronic device of claim 30, wherein the one or more processors are further configured to:
calculate the average load rate using the following formula:
$$\frac{\begin{matrix}\frac{RSRP of the serving cell}{SINR of the serving cell} - Noise power on a pilot RE of the serving cell - Sum \\ of RSRP of intra - frequency synchronous neighboring cells in the neighboring cells\end{matrix}}{\begin{matrix}Sum of data signal power of the neighboring cells on a unit RE \\ measured by the user equipment in the case of full load\end{matrix}} ,$$
wherein a first subcarrier frequency of the intra-frequency synchronous neighboring cell is the same as a second subcarrier frequency of the serving cell, wherein the intra-frequency synchronous neighboring cell is synchronous with the serving cell, and wherein a pilot resource element (RE) carries the pilot signal; and
calculate the sum of the RSRP of the intra-frequency synchronous neighboring cells and the sum of the data signal power on the RE based on at least one of the quantity of antenna transmit, the first probability, the second probability, and the ratio.

33. The electronic device of claim 30, wherein the one or more processors are further configured to calculate the average load rate using the following formula:
$${L}_{N} = \frac{( \frac{RSRP ( i = 0 )}{SINR ( i = 0 )} ) - {N}_{0} - {\sum }_{i ∈ Intra - frequency neighboring cells} ( P ( B ) \times RSRP ( i ) )}{\begin{matrix}{\sum }_{i ∈ Intra - frequency neighboring cells} ( P ( A ) \times n \times {ρ}_{A} \times RSRP ( i ) ) + \\ {\sum }_{i ∈ Inter - frequency neighboring cells} ( P ( A ) \times {ρ}_{A} + P ( B ) \times {ρ}_{B} ) \times n \times RSRP ( i )\end{matrix}} ,$$
wherein i represents a cell number, i=0 represents the serving cell,
$$( \frac{RSRP ( i = 0 )}{SINR ( i = 0 )} )$$
represents a ratio of the RSRP of the serving cell to a signal-to-interference-plus-noise ratio (SINR) of the serving cell, N₀ is noise on a pilot resource element (RE) of the serving cell, RSRP(i) represents an RSRP of a neighboring cell whose number is i, P(A) is the second probability, P(B) is the first probability, ρ_{A} is a first ratio of data signal power to pilot signal power on a non-pilot symbol, ρ_{B} is a second ratio of data signal power to pilot signal power on a pilot symbol, and wherein n is the quantity of antenna transmit ports.

34. The electronic device of claim 30, wherein the one or more processors are further configured to calculate the interference based on the average load rate and at least one of the quantity of antenna transmit ports, the first probability, the second probability, and the ratio.

35. The electronic device of claim 30, wherein the one or more processors are further configured to:
calculate the interference using the following formula:
(sum of the data signal power of the neighboring cells by the user equipment on an orthogonal frequency-division multiplexing (OFDM) symbol and in total bandwidth in the case of full load)×average load rate of the neighboring cells+(sum of an RSRP of the intra-frequency synchronous neighboring cells on the OFDM symbol and in the total bandwidth),
wherein a carrier frequency of the intra-frequency synchronous neighboring cell is the same as a carrier frequency of the serving cell, and wherein the intra-frequency synchronous neighboring cell is synchronous with the serving cell; and
calculate the sum of the data signal power and the sum of the RSRP of the intra-frequency synchronous neighboring cells based on at least one of the quantity of antenna transmit ports, the first probability, the second probability, or the ratio.
